(19) United States
(12) Patent Application Publication
(10) Pub. No.: US 2026/0237165 A1
(43) Pub. Date: Aug. 13, 2026

(54) PRESENTING ENHANCED VIDEO-PASSTHROUGH IN A THREE-DIMENSIONAL ENVIRONMENT

(71) Applicant: Apple Inc., Cupertino, CA (US)

(72) Inventors: Yuri PEKELNY, Seattle, WA (US); Matthew L. STERN, Hermosa Beach, CA (US); Omar R. KHAN, San Ramon, CA (US); Daniel KURZ, San Francisco, CA (US); Ransen NIU, Sunnyvale, CA (US); Angel Suet Yan CHEUNG, San Francisco, CA (US); Jonathan PERRON, Felton, CA (US); Karen N. WONG, Sunnyvale, CA (US); Swapnil MENGADE, Sunnyvale, CA (US)

(21) Appl. No.: 19/447,930

(22) Filed: Jan. 13, 2026

Related U.S. Application Data
(60) Provisional application No. 63/755,993, filed on Feb. 7, 2025.
(60) Provisional application No. 63/885,927, filed on Sep. 22, 2025.

(51) Int. Cl. G06T 19/00; G06F 3/0346; G06T 3/4053; G06T 5/70; G06T 5/90; G06T 7/30

(52) U.S. Cl. CPC G06T 19/006; G06F 3/0346; G06T 3/4053; G06T 5/70; G06T 5/90; G06T 7/30

(57) ABSTRACT

Methods and apparatuses for presenting enhanced video-passthrough in a three-dimensional environment. In some examples, a first electronic device is in communication with one or more input devices. In some examples, the electronic device identifies a region within a three-dimensional environment, captures, via the one or more input devices, one or more first images associated with the region identified within the three-dimensional environment, identifies respective portions of the one or more first images corresponding to the identified region, and generates one or more second images based on the identified respective portions of the one or more first images, wherein the one or more second images have an enhanced visual characteristic relative to that of the one or more first images.

### CROSS REFERENCE TO RELATED APPLICATIONS

This application claims the benefit of U.S. Provisional Application No. 63/885,927, filed Sep. 22, 2025, and U.S. Provisional Application No. 63/755,993, filed Feb. 7, 2025, the contents of which are herein incorporated by reference in their entireties for all purposes.

### FIELD OF THE DISCLOSURE

This relates generally to systems and methods of presenting enhanced video-passthrough in a three-dimensional environment.

### BACKGROUND OF THE DISCLOSURE

Some computer graphical environments provide two-dimensional (2D) and/or three-dimensional (3D) environments where at least some objects displayed for a user's viewing are virtual and generated by a computer. In some examples, these computer graphical environments provide an enhanced video-passthrough.

### SUMMARY OF THE DISCLOSURE

Some examples of the disclosure are directed to systems and methods for presenting enhanced video-passthrough in a three-dimensional environment. In some examples, an electronic device is in communication with one or more input devices. In some examples, the electronic device identifies a region within a three-dimensional environment, captures, via the one or more input devices, one or more first images associated with the region identified within the three-dimensional environment, identifies respective portions of the one or more first images corresponding to the identified region, and generates one or more second images based on the identified respective portions of the one or more first images, wherein the one or more second images have an enhanced visual characteristic relative to that of the one or more first images. In some examples, a first electronic device is in communication with one or more input devices, one or more displays, and a second electronic device. In some examples, while the first electronic device presents, via the one or more displays, a user interface element including one or more first images of a three-dimensional environment of a second electronic device, the first electronic device identifies a region within the one or more first images and presents, via the one or more displays, one or more second images based on the identified region. In some examples, the one or more second images have an enhanced visual characteristic relative to a respective visual characteristic of the one or more first images.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting a three-dimensional environment according to some examples of the disclosure.

FIGS. 2A-2B illustrate block diagrams of example architectures for electronic devices according to some examples of the disclosure.

FIGS. 3A-3G, 4A-4C, and 5A-5C illustrate examples of presenting enhanced video-passthrough in a three-dimensional environment according to some examples of the disclosure.

FIG. 6 illustrates an example process for generating an enhanced video-passthrough in a three-dimensional environment according to some examples of the disclosure.

FIG. 7 illustrates a flow diagram illustrating an example process for presenting enhanced video-passthrough in a three-dimensional environment according to some examples of the disclosure.

FIGS. 8A-8J illustrate examples of presenting enhanced video in a three-dimensional environment according to some examples of the disclosure.

FIG. 9 illustrates a flow diagram illustrating an example process for presenting enhanced video in a three-dimensional environment according to some examples of the disclosure.

### DETAILED DESCRIPTION

Some examples of the disclosure are directed to methods and apparatuses for generating and presenting an enhanced video-passthrough in a three-dimensional environment. In some examples, an electronic device is in communication with one or more input devices. In some examples, the electronic device identifies a region within a three-dimensional environment. In some examples, the electronic device captures, via the one or more input devices, one or more first images associated with the region identified within the three-dimensional environment. In some examples, the electronic device identifies respective portions of the one or more first images corresponding to the identified region. In some examples, the electronic device generates one or more second images based on the identified respective portions of the one or more first images. In some examples, the one or more second images have an enhanced visual characteristic relative to that of the one or more first images. In some examples, a first electronic device is in communication with one or more input devices, one or more displays, and a second electronic device. In some examples, while the first electronic device presents, via the one or more displays, a user interface element including one or more first images of a three-dimensional environment of a second electronic device, the first electronic device identifies a region within the one or more first images and presents, via the one or more displays, one or more second images based on the identified region. In some examples, the one or more second images have an enhanced visual characteristic relative to a respective visual characteristic of the one or more first images.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as a viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

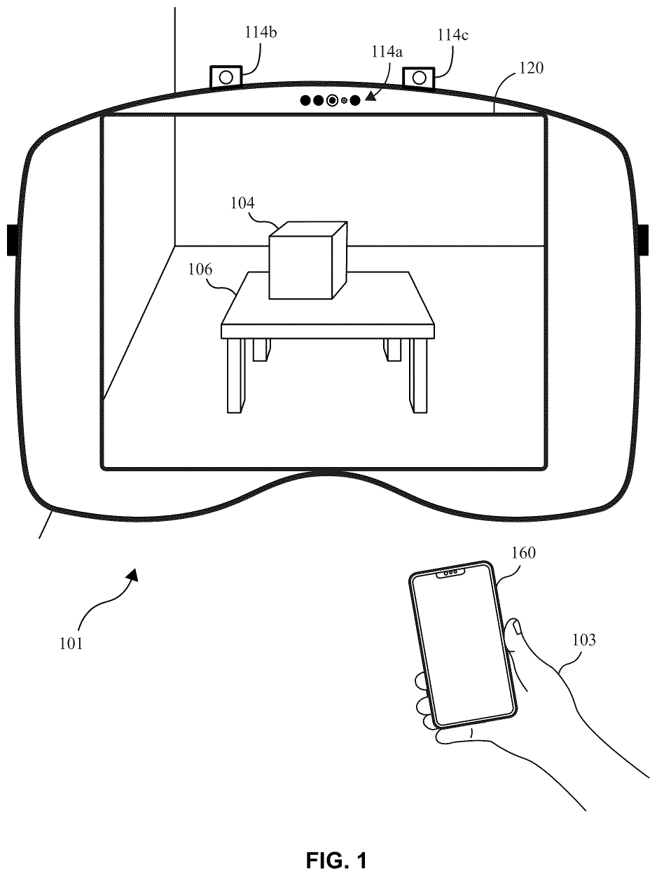

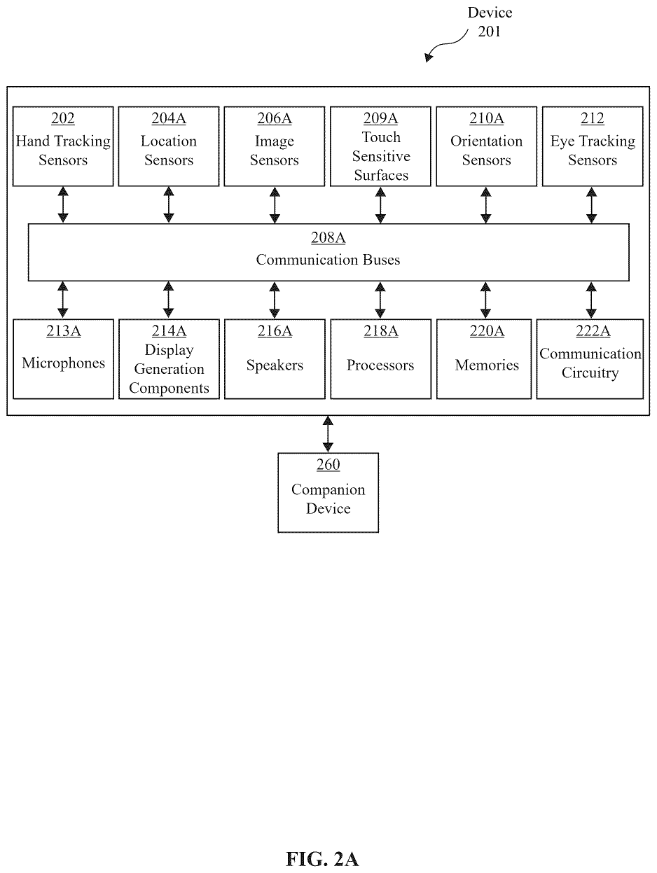

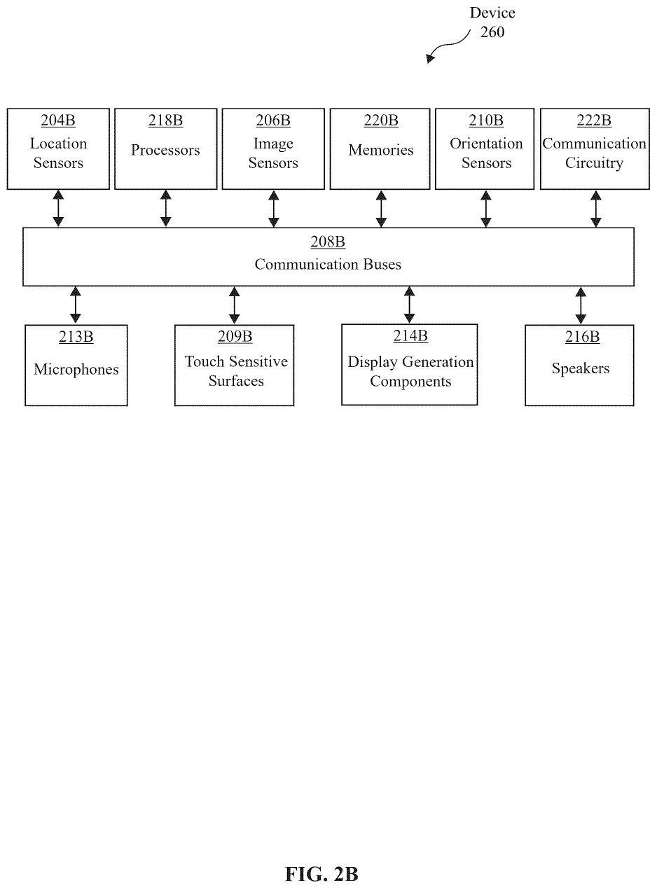

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

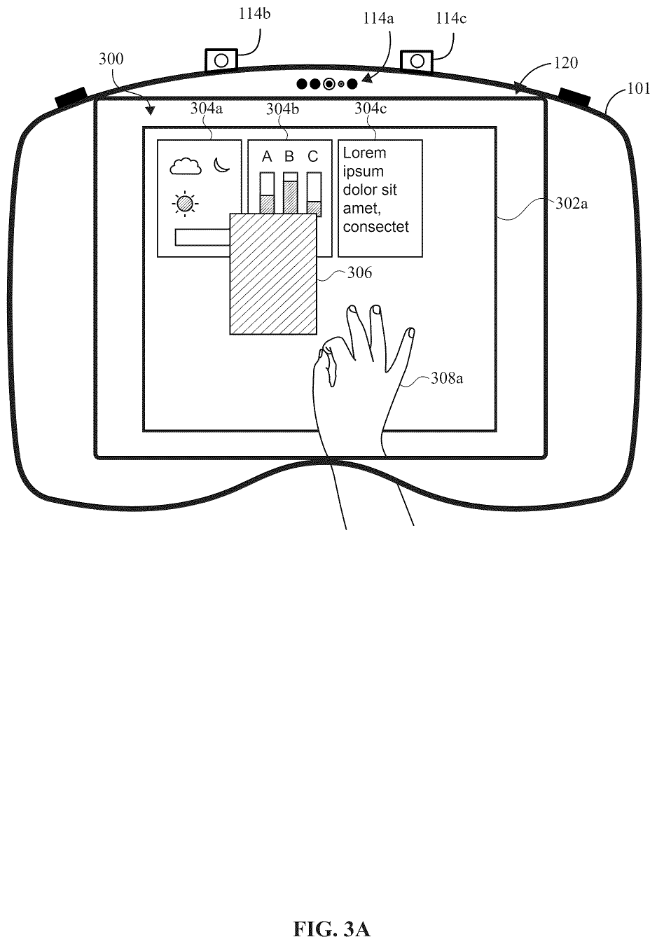

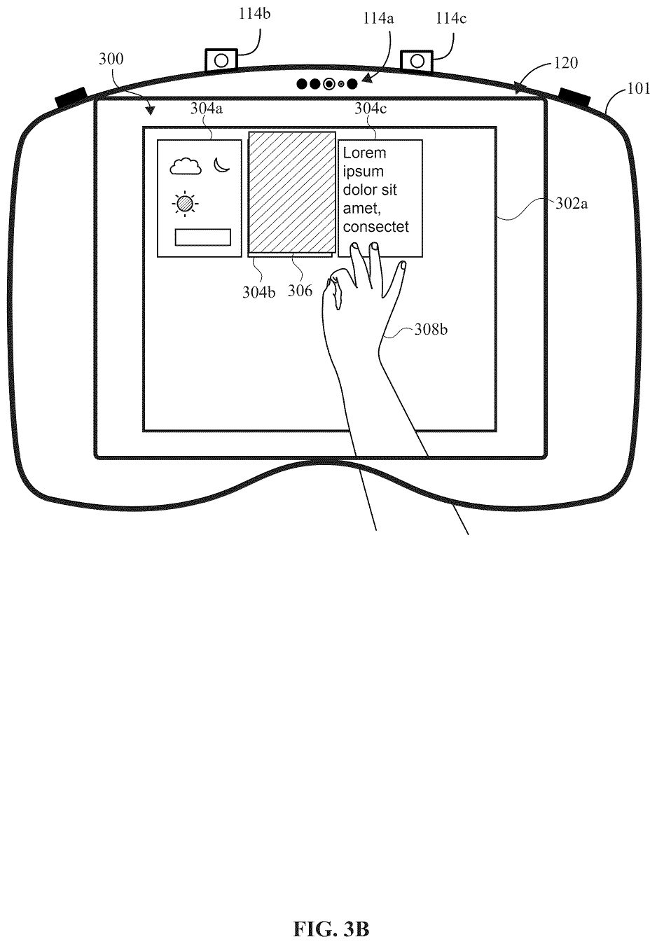

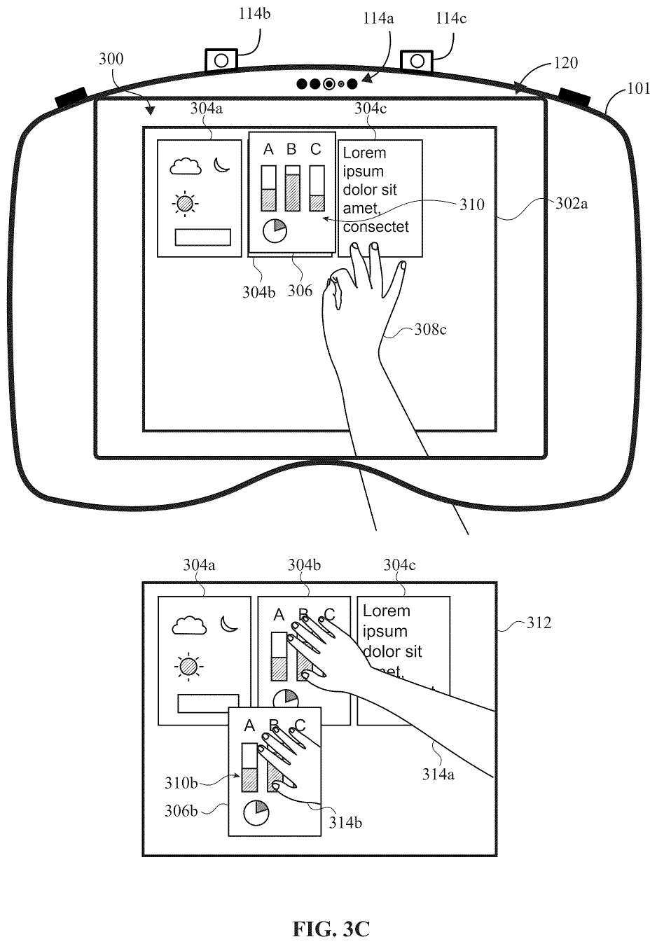

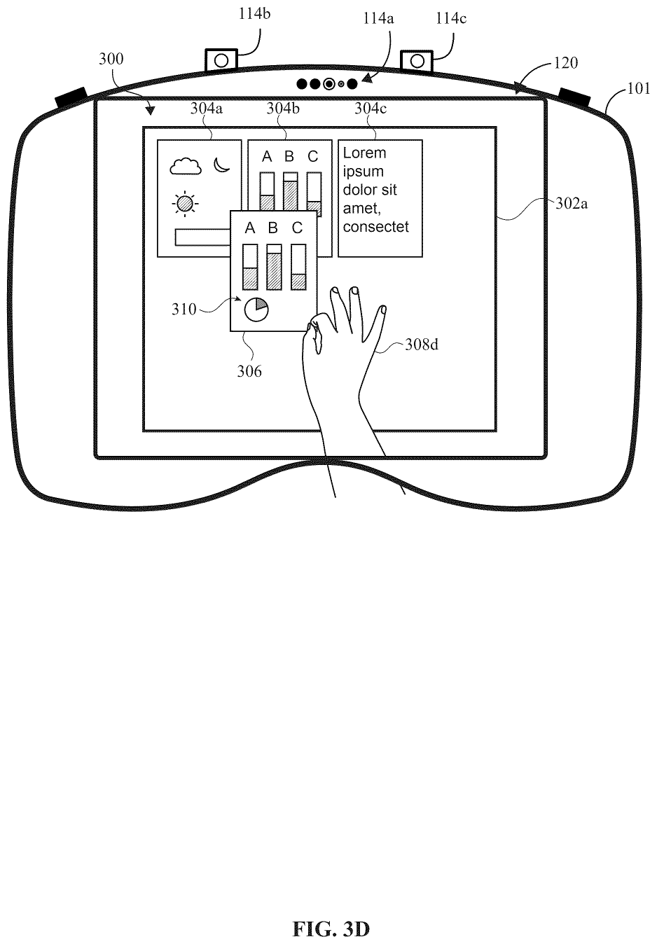

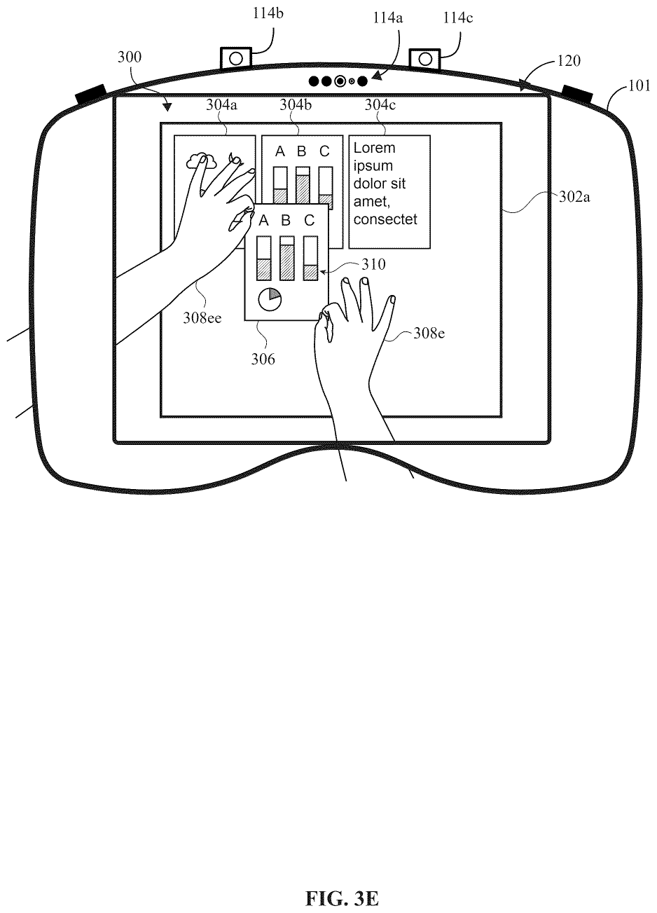

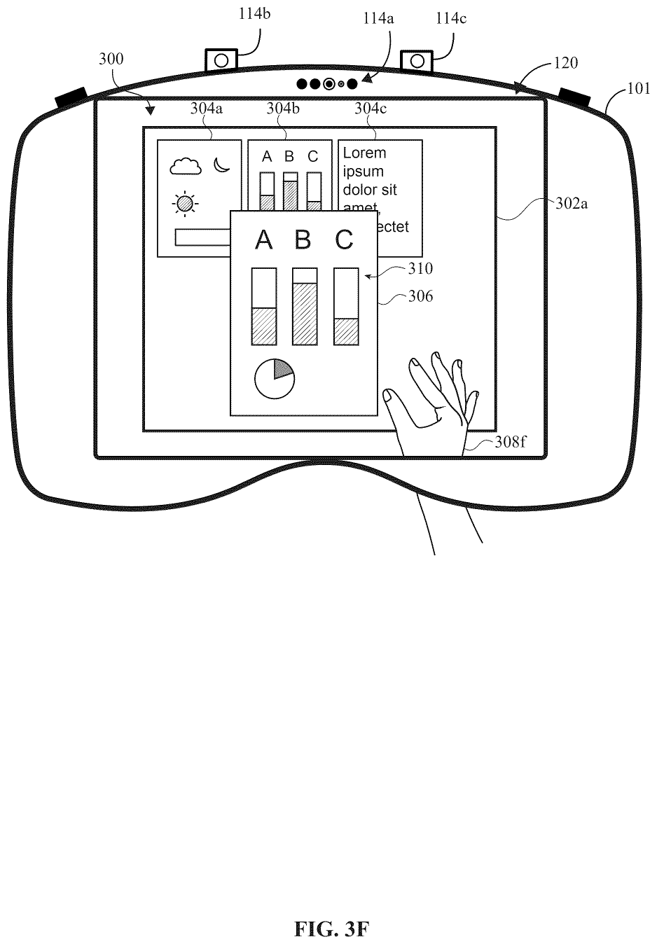

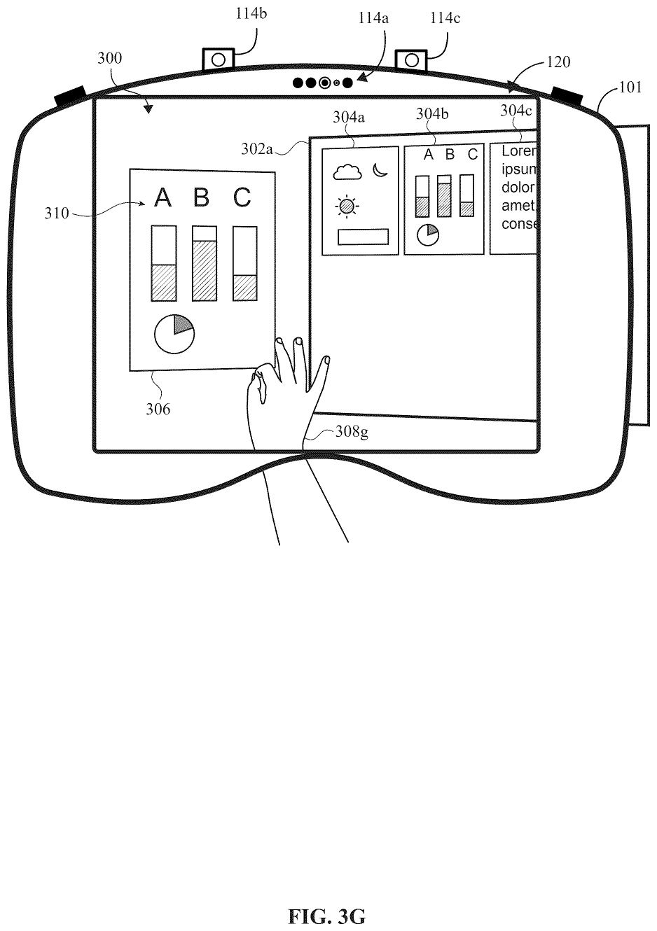

Attention is now directed towards interactions with one or more virtual objects that are displayed in a three-dimensional environment presented at an electronic device (e.g., corresponding to electronic device 201). In some examples, and as will be described in more detail below with reference to FIGS. 3A-3G, 4A-4C, and 5A-5C, the three-dimensional environment includes representations of portions of the physical environment and/or representations of real physical objects in the physical environment displayed by the one or more displays (e.g., display 120) of the electronic device 101 as video-passthrough. In some examples, the electronic device 101 visually enhances the representations of the portions of the physical environment and/or the representations of the real physical object, such as, for example, presenting the representations of the portions of the physical environment and/or the representations of the real physical objects, via the one or more displays, with an enhanced visual characteristic, such as a higher pixel resolution, increased level of detail, improved clarity, higher quality, increased size, increased contrast, increased sharpness, increased color vibrancy, increased text readability, less noise, or the like, than presenting the portions of the physical environment and/or real physical objects as unenhanced video-passthrough or optical-passthrough, wherein the portions of the physical environment and/or real physical objects are optically visible through one or more partially or fully transparent portions of the one or more displays.

FIGS. 3A-3G, 4A-4C, and 5A-5C illustrate examples of presenting enhanced video-passthrough in a three-dimensional environment according to some examples of the disclosure. FIG. 3A illustrates electronic device 101 (e.g., electronic device 101 of FIG. 1; and electronic device 201 of FIG. 2) presenting a three-dimensional environment 300 (e.g., an extended reality (XR) environment, a computer-generated environment, etc.) according to some examples of the disclosure. The three-dimensional environment 300 is visible from a viewpoint of a user of the electronic device 101. In some examples, the electronic device 101 is a hand-held or mobile device, such as a tablet computer, laptop computer, smartphone, a wearable device, or head-mounted display. Examples of the electronic device 101 are described above with reference to the architecture block diagram of FIG. 2. As shown in FIG. 3A, the electronic device 101 and a content board 302a (e.g., whiteboard, corkboard, and/or the like) are located in the physical environment of the three-dimensional environment 300. As illustrated in FIG. 3A, physical posters 304a, 304b, and 304c include a variety of respective content (e.g., text, images, graphics, and/or the like) and are posted on the content board 302a. In some examples, the electronic device 101 may be configured to capture areas of the physical environment including the content board 302a.

In some examples, the viewpoint of the user of the electronic device 101 determines what content is visible in a viewport (e.g., a view of the three-dimensional environment visible to the user via one or more displays, such as the one or more image sensors 206, or a pair of display modules that provide stereoscopic content to different eyes of the same user). In some examples, the (virtual) viewport has a viewport boundary that defines an extent of the three-dimensional environment that is visible to the user via the one or more displays (e.g., display 120 in FIGS. 3A-3G, 4A-4C, and 5A-5C). In some examples, the region defined by the viewport boundary is smaller than a range of vision of the user in one or more dimensions (e.g., based on the range of vision of the user, size, optical properties or other physical characteristics of the one or more displays, and/or the location and/or orientation of the one or more displays relative to the eyes of the user). In some examples, the region defined by the viewport boundary is larger than a range of vision of the user in one or more dimensions (e.g., based on the range of vision of the user, size, optical properties or other physical characteristics of the one or more displays, and/or the location and/or orientation of the one or more displays relative to the eyes of the user). The viewport and viewport boundary typically move as the one or more displays move (e.g., moving with a head of the user for a head-mounted device or moving with a hand of the user for a handheld device such as a tablet or smartphone). A viewpoint of the user determines what content is visible in the viewport, a viewpoint generally specifies a location and a direction relative to the three-dimensional environment, and as the viewpoint shifts, the view of the three-dimensional environment will also shift in the viewport. For a head-mounted device, a viewpoint is typically based on a location, a direction of the head, face, and/or eyes of the user to provide a view of the three-dimensional environment that is perceptually accurate and provides an immersive experience when the user is using the head-mounted device. For a handheld or stationed device, the viewpoint shifts as the handheld or stationed device is moved and/or as a position of the user relative to the handheld or stationed device changes (e.g., a user moving toward, away from, up, down, to the right, and/or to the left of the device). For devices that include one or more displays with video-passthrough (or, optionally, referred to as virtual-passthrough), portions of the physical environment that are visible (e.g., displayed, and/or projected) via the one or more displays are based on a field of view of one or more cameras in communication with the one or more displays which typically move with the one or more displays (e.g., moving with a head of the user for a head-mounted device or moving with a hand of the user for a handheld device such as a tablet or smartphone) because the viewpoint of the user moves as the field of view of the one or more cameras moves (and the appearance of one or more virtual objects displayed via the one or more displays is updated based on the viewpoint of the user (e.g., displayed positions and poses of the virtual objects are updated based on the movement of the viewpoint of the user)). For the one or more displays with optical-passthrough, portions of the physical environment that are visible (e.g., optically visible through one or more partially or fully transparent portions of the display generation component) via the one or more display generation components are based on a field of view of the user through the partially or fully transparent portion(s) of the display generation component (e.g., moving with a head of the user for a head-mounted device or moving with a hand of the user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

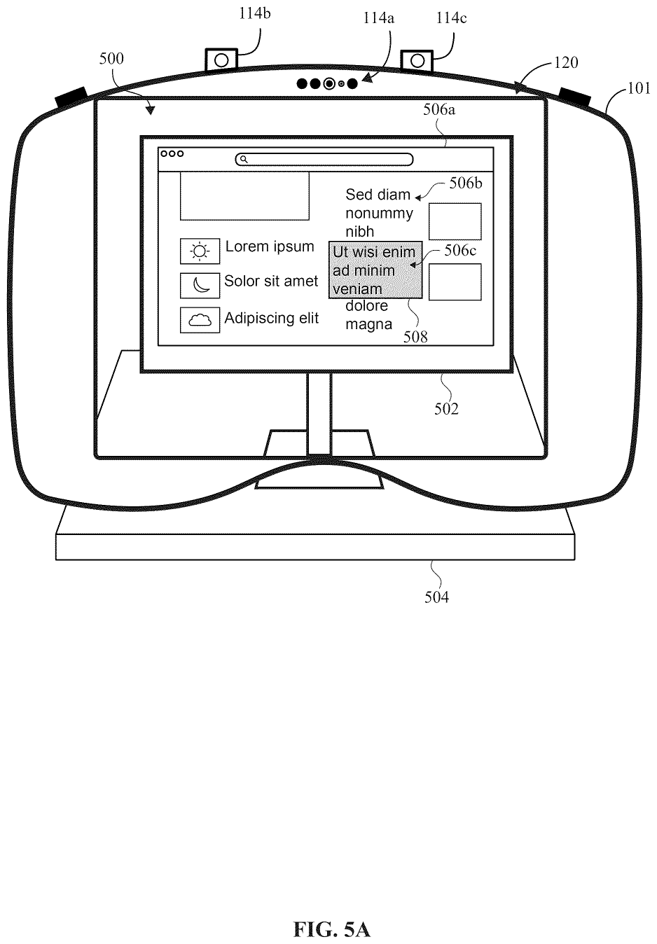

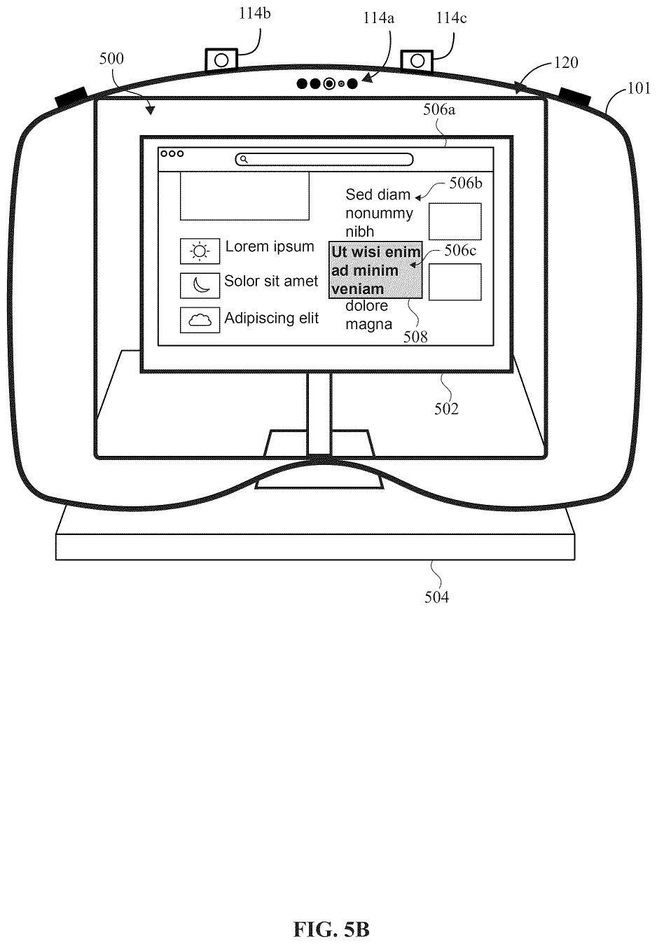

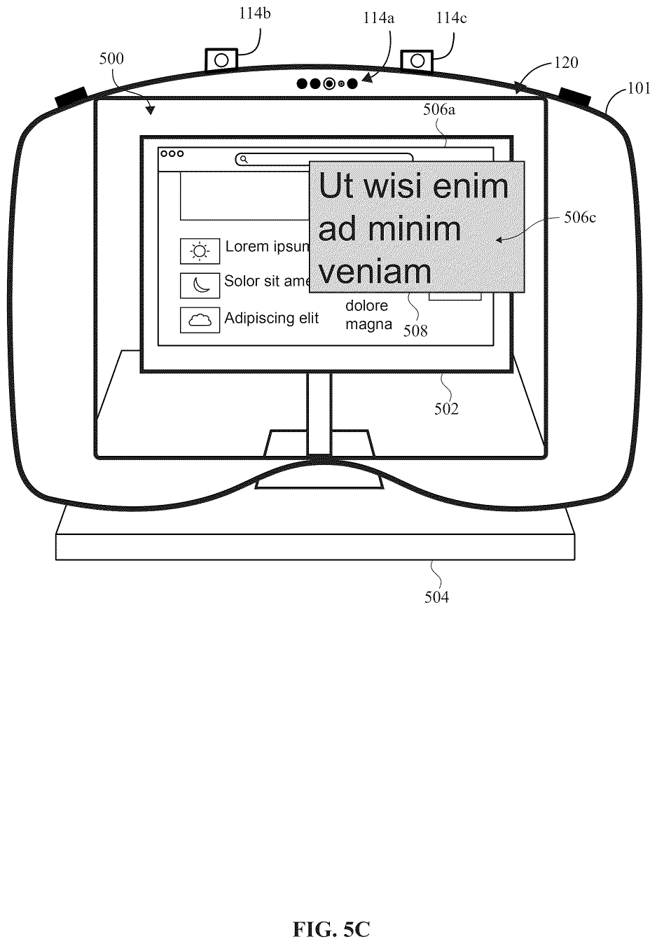

In some examples, the electronic device 101 performs a video-passthrough enhancement operation on a region and/or physical object within the three-dimensional environment 300. For example, and as illustrated in FIG. 3A, the electronic device 101 displays, via display 120, user interface element 306 (e.g., virtual object) used to identify a region of interest within the three-dimensional environment 300. It is understood that although the examples as described herein are directed to the user interface element 306 having a particular shape, such as a rectangular shape as illustrated in FIG. 3A, the user interface element 306 may include a number of different shapes other than a rectangular shape, such as a circular shape or other shape. In some examples, the user interface element 306 is two-dimensional similar to a user interface window virtual object. In some examples, the user interface element 306 is three-dimensional similar to a user interface volume virtual object. The diagonal line pattern of the user interface element 306 as shown in FIG. 3A is for illustrative purposes and is not necessarily displayed as having the diagonal line pattern or any pattern. For example, as illustrated and described below with reference to FIG. 5A, the electronic device 101 optionally displays the user interface element 306 with a degree of opacity such that objects within the three-dimensional environment 300 are visible through the user interface element 306.

In some examples, the electronic device displays the user interface element 306 with a first size and at a first location within the three-dimensional environment in response to user input or automatically without detecting user input requesting to display the user interface element 306. For example, while the electronic device 101 displays, via display 120, the three-dimensional environment 300 that does not include user interface element 306, the electronic device 101 detects user input, via the one or more input devices, such as a voice input from the user of the electronic device 101 corresponding to a request to perform a video-passthrough enhancement operation. In some examples, in response to detecting this voice input, the electronic device 101 displays the user interface element 306 with the first size and at the first location within the three-dimensional environment 300, as shown in FIG. 3A. In another example, while the electronic device 101 displays, via display 120, the three-dimensional environment 300 that does not include user interface element 306, the electronic device 101 automatically displays the user interface element 306 with the first size and at the first location within the three-dimensional environment 300, as shown in FIG. 3A (e.g., without detecting user input requesting to display the user interface element 306) in response to determining one or more physical objects of a first type are within the three-dimensional environment 300. For example, the first type of physical object optionally includes physical objects having content (e.g., text, characters, and/or images), such as physical posters 304a, 304b, and 304c in FIG. 3A. In some examples, the electronic device 101 displays the user interface element 306 within the three-dimensional environment 300 in accordance with a determination that the three-dimensional environment 300 includes one or more physical objects of the first type. Thus, in some examples, automatically displaying the user interface element 306 and thus, automatically presenting the option to perform the video-passthrough enhancement operation as described herein in accordance with the determination that the three-dimensional environment 300 includes one or more physical objects of the first type notifies the user of the electronic device 101 that one or more physical objects within the three-dimensional environment 300 are candidates for video-passthrough enhancement, which provides the option to enhance and/or provide more easily readable content, thereby improving user-device interaction, which reduces eye strain of the user, thereby avoiding potential physical discomfort for the user caused by viewing content within the three-dimensional environment 300.

In some examples, and as shown in FIG. 3A, the electronic device 101 detects user input, via the one or more input devices, such as air pinch gesture 308a (e.g., two or more fingers of the user's hand such as the thumb and index finger moving together and touching each other) while attention (e.g., gaze) of the user is directed to the user interface element 306. In some examples, the air pinch gesture 308a includes movement from a first location within the three-dimensional environment 300 as shown in FIG. 3A to a second location within the three-dimensional environment 300 as shown in FIG. 3B. In some examples, in response to detecting this user input, the electronic device 101 performs an action to move the user interface element 306 in accordance with the movement of the air pinch gesture. For example, the electronic device 101 moves user interface element 306 from a first location within the three-dimensional environment 300 as shown in FIG. 3A to a second location within the three-dimensional environment 300 as shown in FIG. 3B while the attention of the user is directed to the user interface element 306. In FIG. 3B, the second location of the user interface element 306 corresponds to the location of physical poster 304b. Additionally and/or alternatively, the electronic device 101 moves the user interface element 306 in response to a user input, different from the air pinch gesture based user input, such as contact and movement on a touch-sensitive surface (e.g., touchscreen, trackpad, or touchpad), movement of a physical input device (e.g., movement of a hand held input device, such as a mouse, stylus, controller, or other motion tracking device that detects direction and/or magnitude of movement of the physical input device while it is being held in the hand of the user and/or rotating a physical click wheel or a rotatable input device, such as rotation of a digital crown), a voice input, a gaze of the user of the electronic device, and/or other predefined gesture or input described herein.

In some examples, in response to detecting user interface element 306 at the second location corresponding to the location of physical poster 304b, the electronic device 101 performs a video-passthrough enhancement operation including capturing, via the one or more input devices, one or more first images associated with a region within the three-dimensional environment 300 contained within the user interface element 306, and generating for display, via the display 120, one or more second images based on the one or more first images. In some examples, the one or more second images have higher pixel resolution than the one or more first images. For example, in FIG. 3C, the electronic device displays within user interface element 306 image 310 having a higher pixel resolution than a view of the physical poster 304b via the display 120. Thus, in some examples, displaying image 310 having the higher pixel resolution than the view of the physical poster 304b via the display 120 provides an enhanced view of the content, which reduces eye strain of the user, thereby avoiding potential physical discomfort for the user caused by viewing content within the three-dimensional environment 300. In some examples, the one or more second images have a different enhanced visual characteristic, such as an increased level of detail, improved clarity, higher quality, increased size, increased contrast, increased sharpness, increased color vibrancy, increased text readability, less noise, or the like. In some examples, the electronic device 101 displays image 310 in response to a determination that one or more criteria are satisfied. For example, the one or more criteria include a criterion that is satisfied when the electronic device 101 determines that the user interface element 306 is at the second location corresponding to the location of physical poster 304b for longer than a predetermined threshold of time (e.g., 0.5, 0.7, 1, 3, 5, 10, 20, or 30 seconds). In some examples, the electronic device 101 performs the video-passthrough enhancement operation in response to user interface element 306 being displayed, without detecting that user interface element 306 is at a location corresponding to a physical object, such as in the example of FIG. 3A.

In some examples, the electronic device 101 displays the user interface element 306 at the second location corresponding to the location of physical poster 304b, as shown in FIG. 3C in accordance with a determination that a current location of the user interface element 306 is within a threshold distance (e.g., 0.1, 0.5, 1, 5, 10, 50, or 100 centimeters) from the location of the physical poster 304b. Thus, in some examples, the electronic device 101 performs a “snapping” operation to snap the user interface element 306 to the location of the physical poster 304b such that the user interface element 306 is overlaid over the physical poster 304b. In some examples, the electronic device 101 recognizes, using object recognition and tracking, the physical poster 304b and optionally changes a size and/or shape of the user interface element 306 to match the size and/or shape of the physical poster 304b such that the electronic device 101 captures the physical poster 304b in its entirety. In some examples, and as will be described below with reference to FIG. 5A, the electronic device 101 captures a portion of the three-dimensional environment (e.g., a portion of the physical poster 304b).

FIG. 3C also illustrates another view 312 of the three-dimensional environment 300 displayed via display 120. View 312 illustrates that user interface element 306b is a virtual object that includes captured video imagery 310b of a portion of the three-dimensional environment 300. For example, the captured video imagery 310b includes content corresponding to content of the physical poster 304b in the three-dimensional environment 300 and a portion 314b of the hand of the user corresponding to the hand 314a of the user in the three-dimensional environment 300. Thus, in some examples, the electronic device displays user interface elements/virtual objects that include captured video imagery of the three-dimensional environment so as to, in some examples, provide an enhanced “version” of the captured video imagery.

In some examples, the electronic device 101 moves the user interface element including the image 310 having the higher pixel resolution in response to user input. For example, in FIG. 3C, the electronic device 101 detects user input, via the one or more input devices, such as air pinch gesture 308c (e.g., two or more fingers of the user's hand such as the thumb and index finger moving together and touching each other) while attention (e.g., gaze) of the user is directed to the user interface element 306. In some examples, the air pinch gesture 308c includes movement from a first location within the three-dimensional environment 300 as shown in FIG. 3C to a second location within the three-dimensional environment 300 as shown in FIG. 3D. In some examples, in response to detecting this user input, the electronic device 101 performs an action to move the user interface element 306 in accordance with the movement of the air pinch gesture. For example, the electronic device 101 moves user interface element 306 from the second location within the three-dimensional environment 300 as shown in FIG. 3C to a third location within the three-dimensional environment 300 as shown in FIG. 3D while the attention of the user is directed to the user interface element 306. In FIG. 3D, the third location of the user interface element 306 is below the location of physical poster 304b. As shown in FIG. 3D, the electronic device 101 maintains the display the image 310 within the user interface element 306 while and/or in response to moving the user interface element 306 to the third location. Additionally and/or alternatively, the electronic device 101 moves the user interface element 306 including the image 310 in response to a user input, different from the air pinch gesture based user input, such as contact and movement on a touch-sensitive surface (e.g., touchscreen, trackpad, or touchpad), movement of a physical input device (e.g., movement of a hand held input device, such as a mouse, stylus, controller, or other motion tracking device that detects direction and/or magnitude of movement of the physical input device while it is being held in the hand of the user and/or rotating a physical click wheel or a rotatable input device, such as rotation of a digital crown), a voice input, a gaze of the user of the electronic device, and/or other predefined gesture or input described herein.

In some examples, the electronic device 101 resizes the user interface element 306 including the image 310 having the higher pixel resolution in response to user input. For example, in FIG. 3E, the electronic device 101 detects a user input including an air pinch gesture with a first hand 308e and a second hand 308ee of the user and movement to pull the hands apart corresponding to a request to increase the size of the user interface element 306 including the image 310. In some examples, the electronic device 101 detects this user input while the attention (e.g., gaze) of the user is directed to the user interface element 306. As shown in FIG. 3F, in response to this user input, the electronic device 101 increases the size of the user interface element 306 including the image 310 in accordance with the movement of the first hand 308e and the second hand 308ee of the user until the electronic device 101 detects a release of the air pinch gesture, as shown by hand 308f in FIG. 3F.

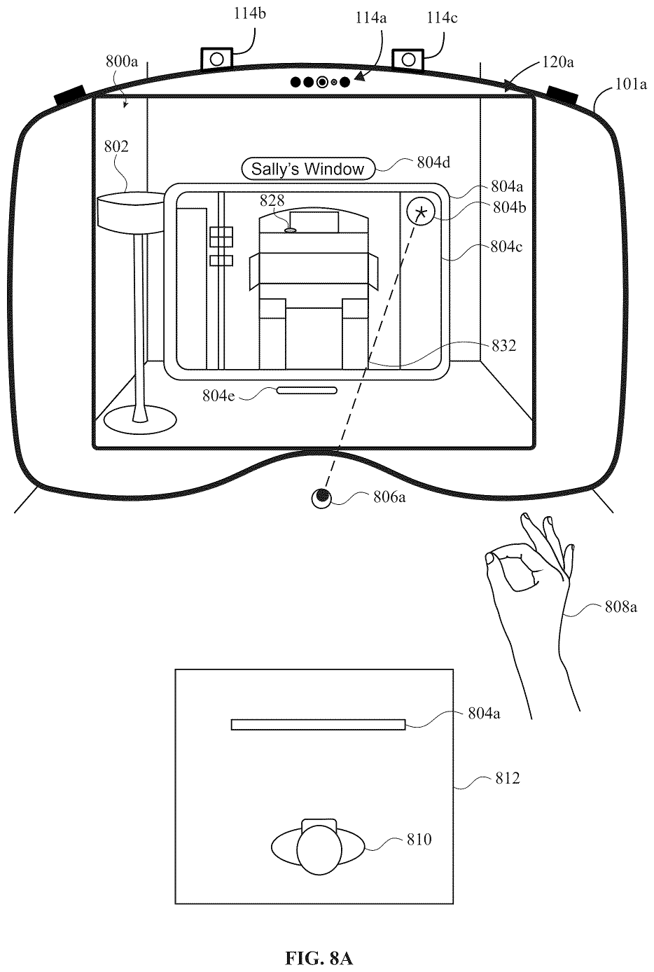

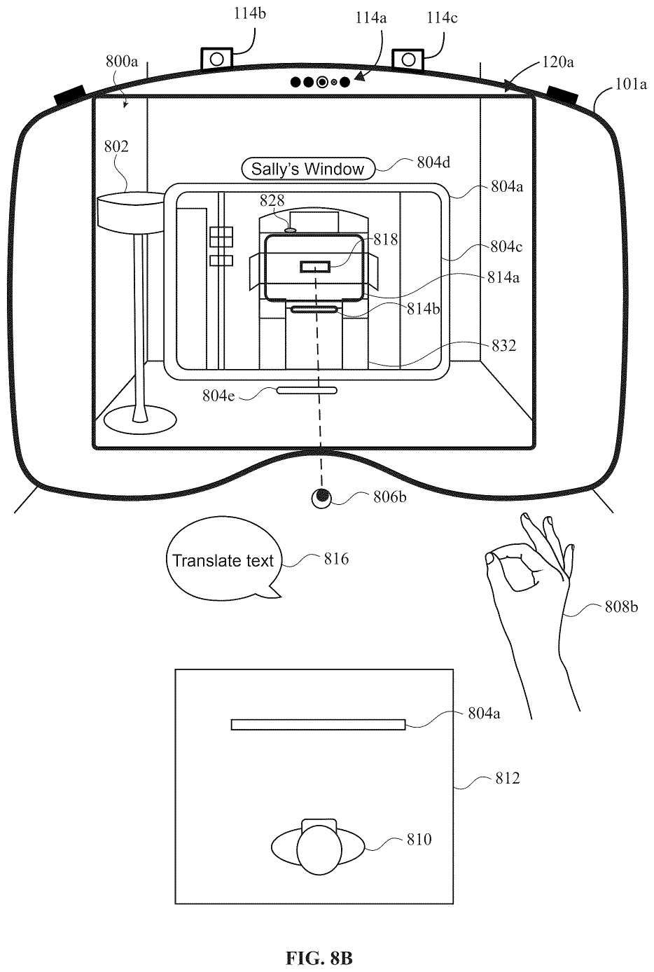

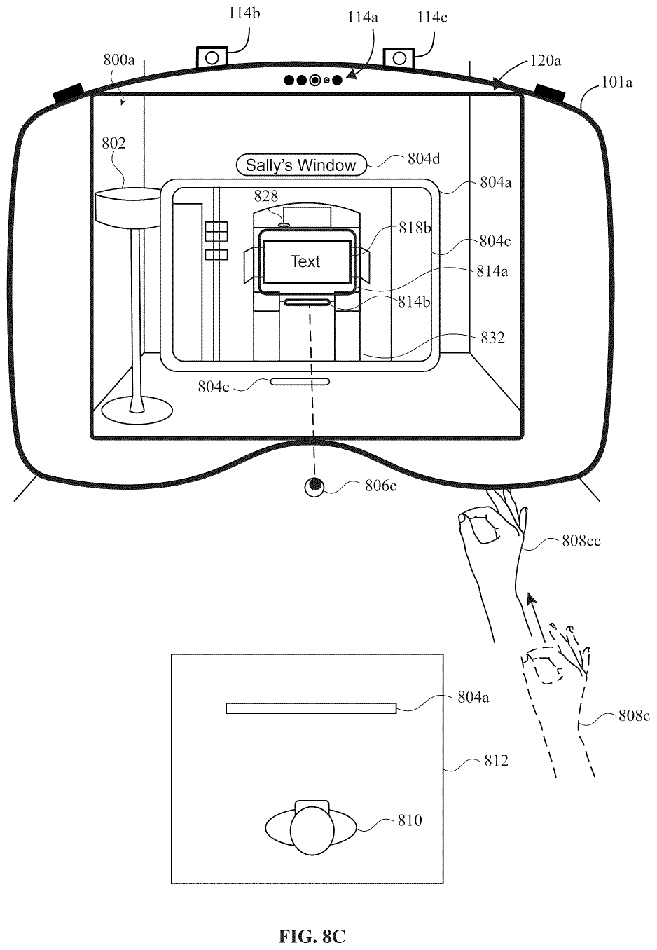

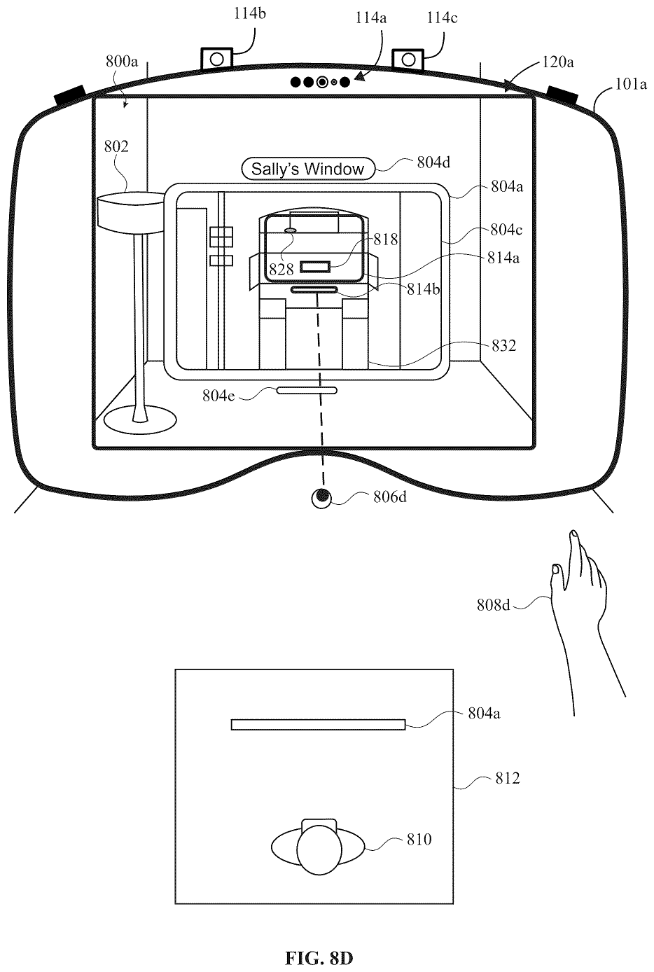

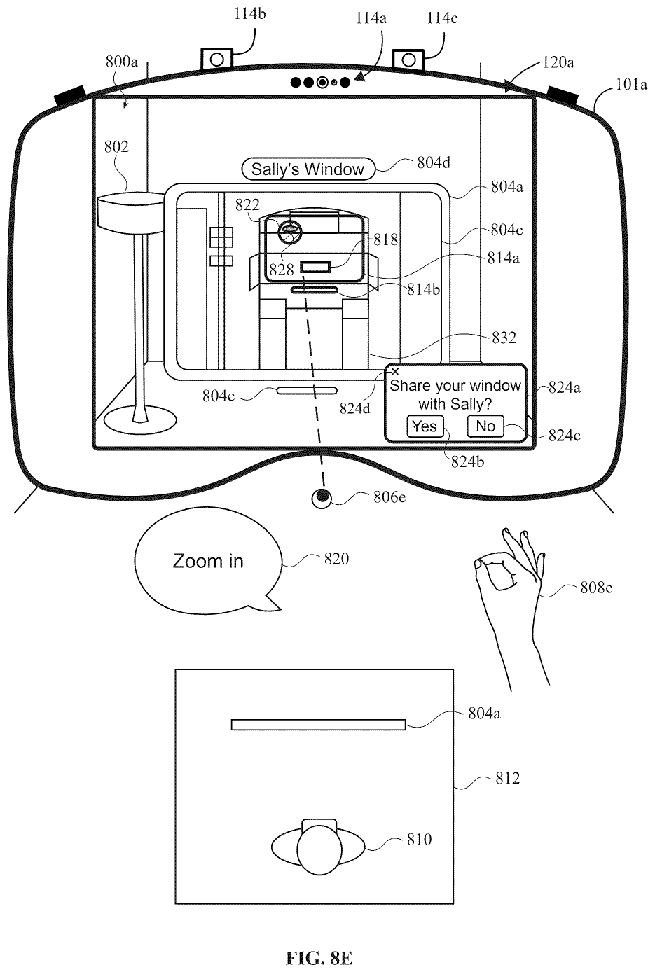

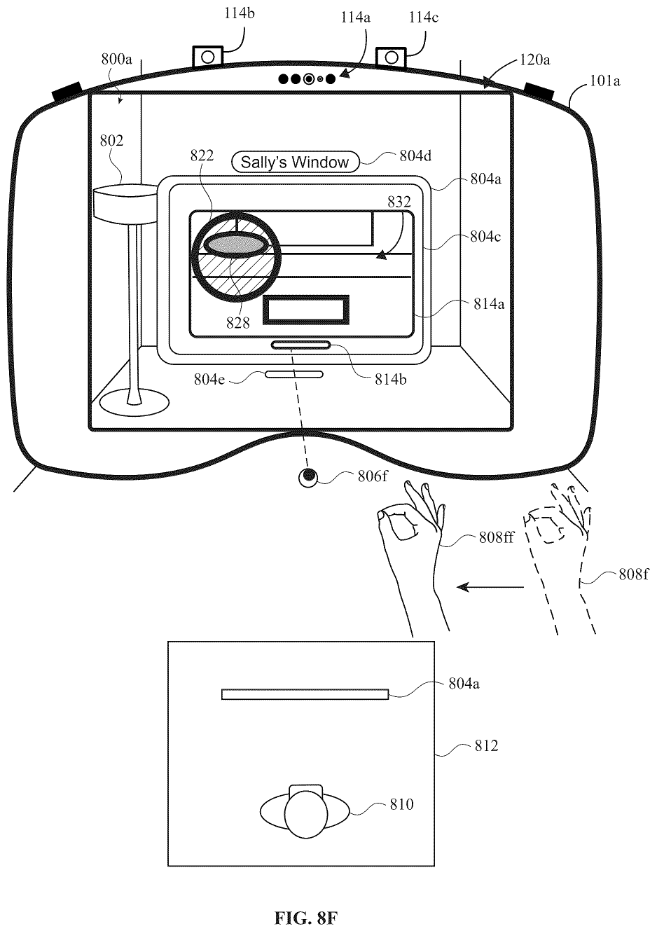

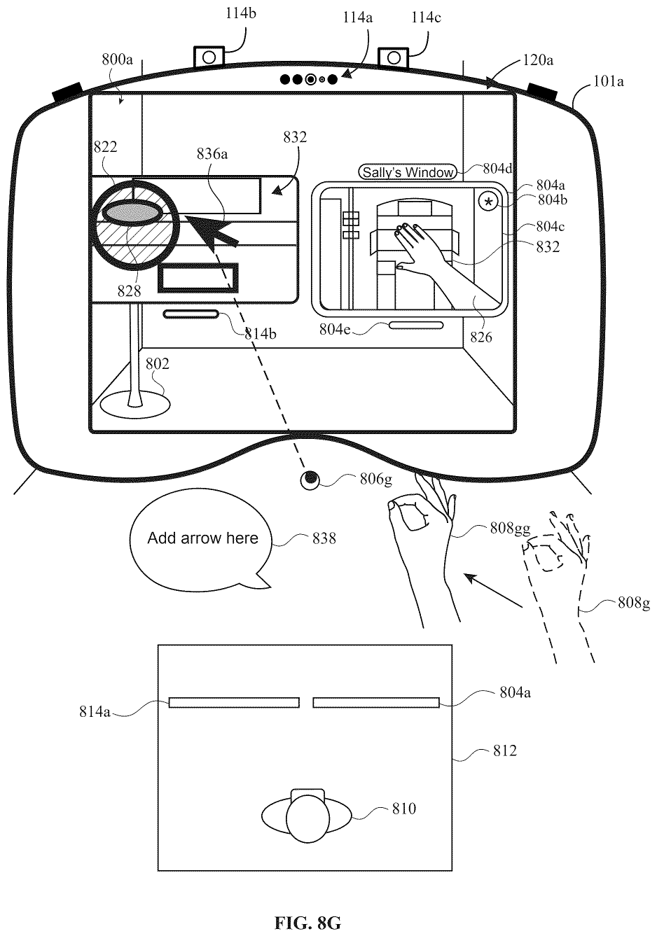

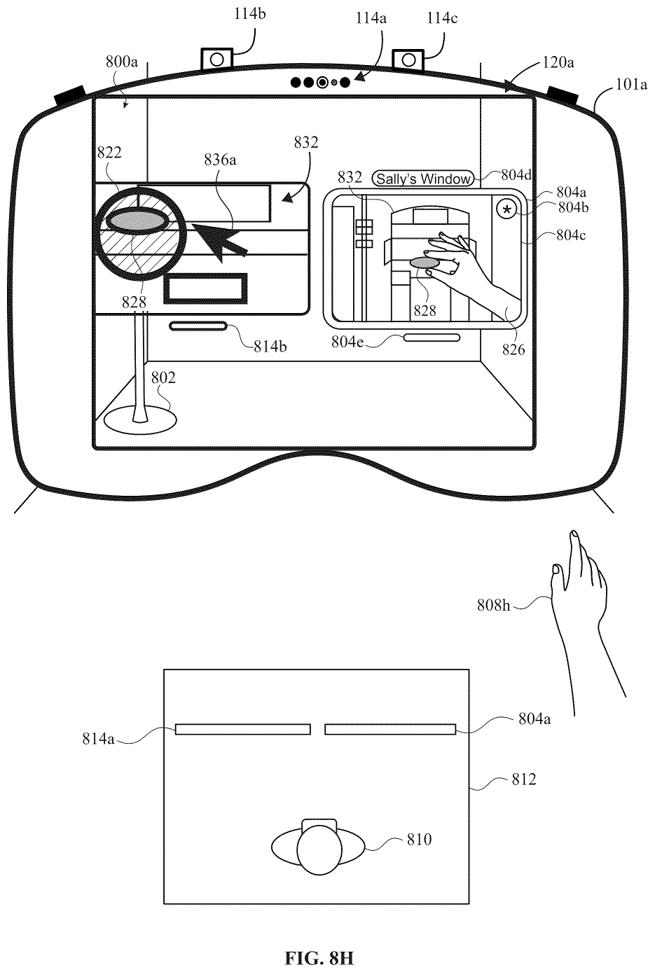

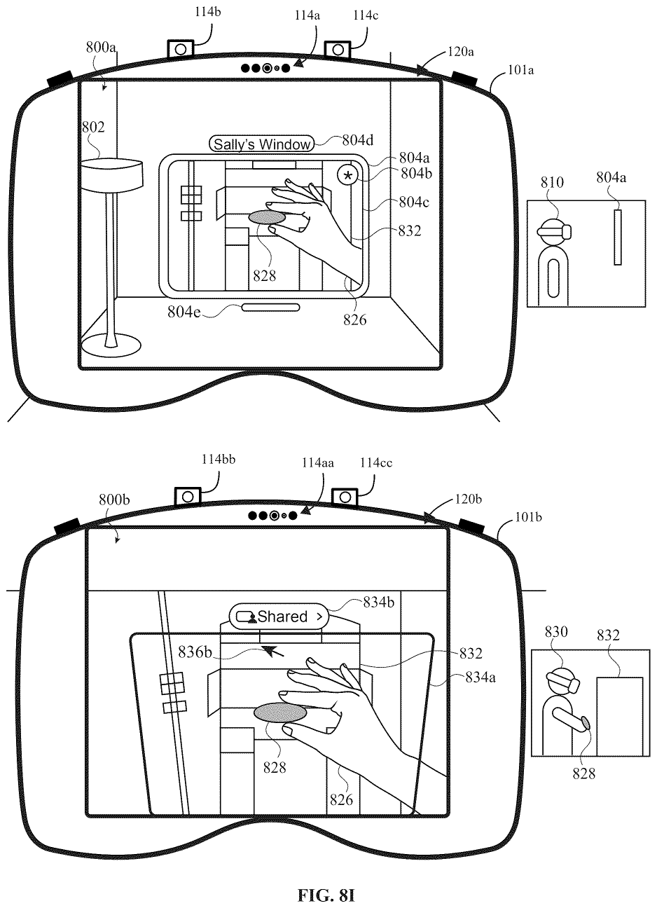

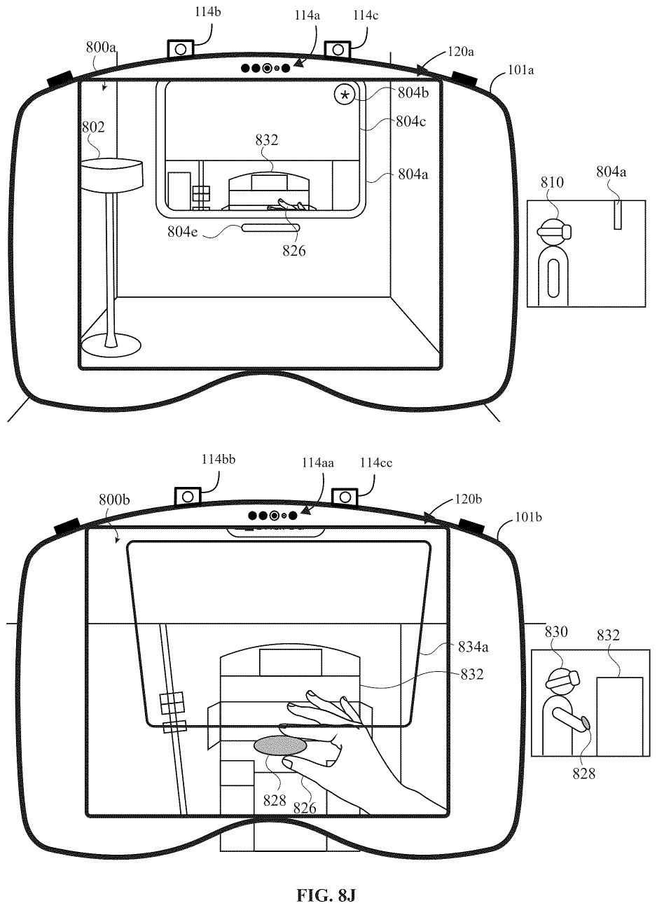

In some examples, the electronic device 101 displays the user interface element 306 including the image 310 with a particular orientation relative to the viewpoint of the user. For example, while the electronic device 101 displays the user interface element 306 including the image 310 having a first orientation relative to the first viewpoint of the user (e.g., facing the first viewpoint), the electronic device 101 detects movement of the user (e.g., the user rotates their head to view the user interface element 306 from a second viewpoint) from the first viewpoint to a second viewpoint. In some examples, while the electronic device 101 detects the movement of the user, the electronic device 101 detects user input, such as air pinch gesture 308g (e.g., two or more fingers of the user's hand such as the thumb and index finger moving together and touching each other) while attention (e.g., gaze) of the user is directed to the user interface element 306. In some examples, in response to detecting this movement of the user and user input, the electronic device 101 performs an action to move the user interface element 306 in accordance with the movement of the air pinch gesture. For example, the electronic device 101 moves user interface element 306 from the first location within the three-dimensional environment 300 as shown in FIG. 3F to a second location within the three-dimensional environment 300 as shown in FIG. 3G. In some examples, while and/or response to moving the user interface element 306 to the second location, the electronic device 101 presents the user interface element 306 including the image 310 with an orientation facing the second viewpoint of the user, as shown in FIG. 3G. Displaying the user interface element 306 including image 310 with orientations that are based on a respective viewpoint of the user provides an efficient way of presenting content, thereby reducing the number of inputs and providing more efficient interactions between the user and the electronic device 101, which enhances operability of the electronic device 101, reduces power usage of the electronic device 101, reduces errors in the interaction between the user and the electronic device 101, and reduces inputs needed to correct such errors. In some examples, the electronic device 101 determines that the respective viewpoint of the user is located further than a threshold distance (e.g., described above) from a respective location associated with image 310. For example, the electronic device 101 determines that the viewpoint of the user corresponds to a viewing angle that is directed towards a region to the right of content board 302a, such that image 310 is not within the field of the view of the user of the electronic device 101. In some examples, in accordance with this determination, the electronic device 101 presents, via the display 120, a notification to recenter the viewpoint of the user relative to the respective location associated with image 310. In some examples, the notification has one or more characteristics of the notification 824a described in more detail with reference to FIG. 8E.

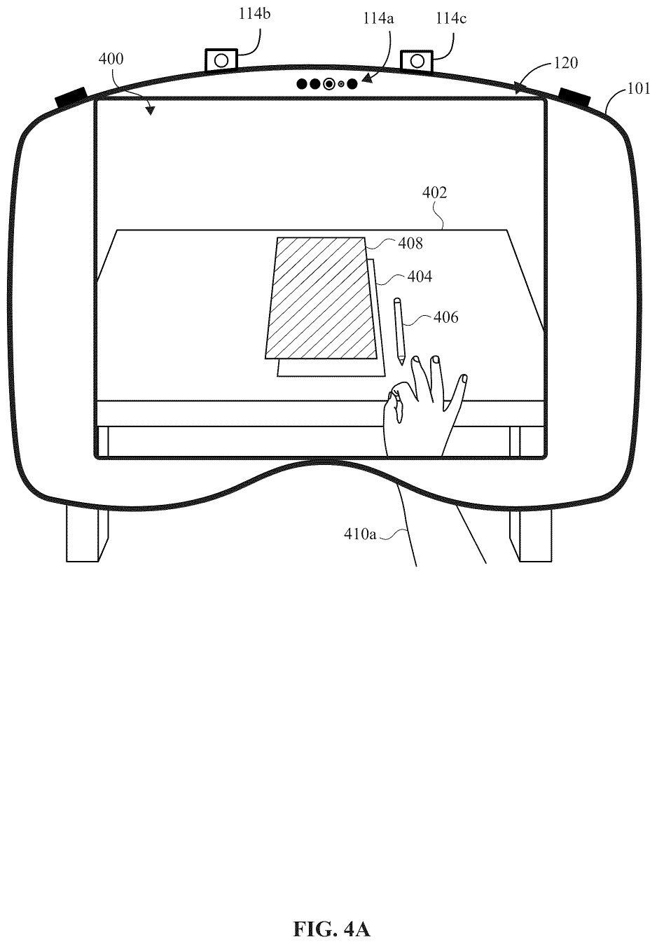

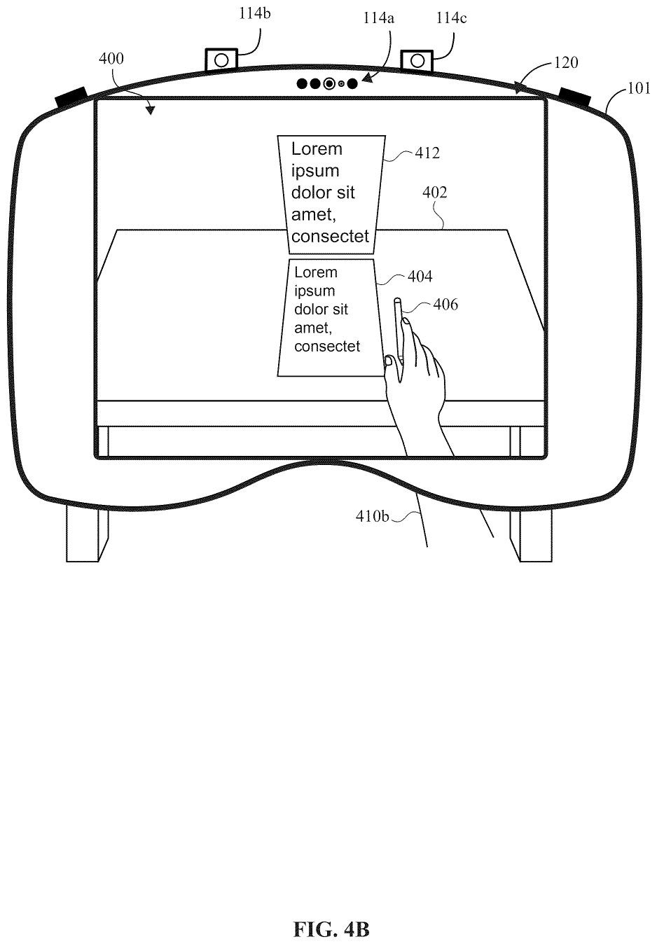

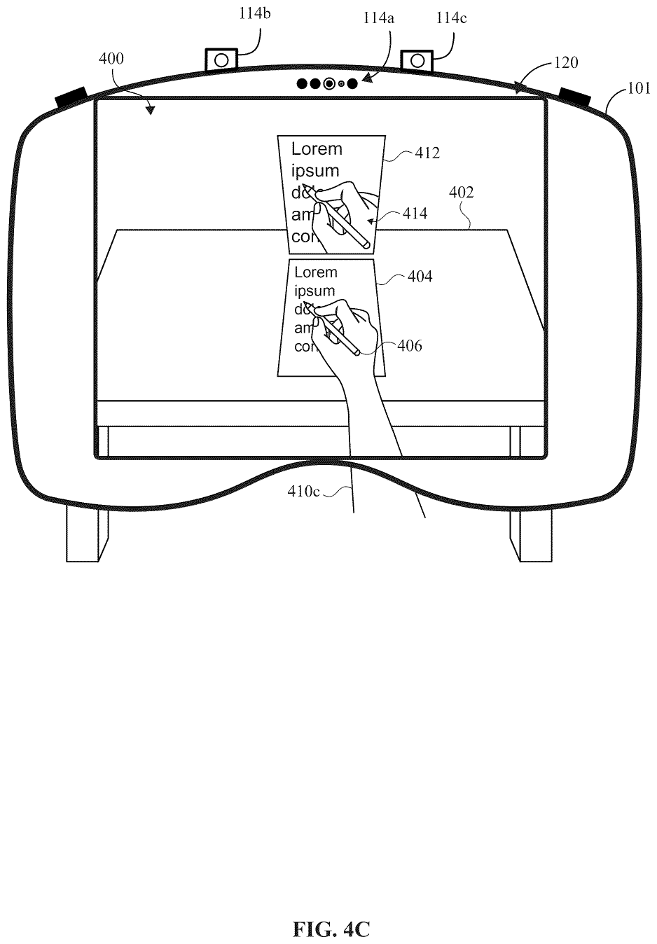

FIGS. 4A-4C illustrate another example of presenting enhanced video-passthrough in a three-dimensional environment according to some examples of the disclosure. FIG. 4A illustrates electronic device 101 (e.g., electronic device 101 of FIG. 1; and electronic device 201 of FIG. 2) presenting a three-dimensional environment 400 (e.g., an extended reality (XR) environment, a computer-generated environment, etc.) according to some examples of the disclosure. The three-dimensional environment 400 is visible from a viewpoint of a user of the electronic device 101. In some examples, the electronic device 101 has one or more characteristics and/or one or more functions of the electronic device 101 in FIG. 3A. As shown in FIG. 4A, the electronic device 101 and a table 402 are located in the physical environment of the three-dimensional environment 400. As illustrated in FIG. 4A, a physical piece of paper 404 and physical writing instrument 406 (e.g., pencil, pen, stylus, and/or the like) are on top of the table 402. In some examples, the electronic device 101 may be configured to capture areas of the physical environment including the paper 404.

In some examples, the electronic device 101 performs a video-passthrough enhancement operation on a physical object within the three-dimensional environment 400. For example, and as illustrated in FIG. 4A, the electronic device 101 identifies the paper 404 and in accordance with a determination that the paper 404 satisfies one or more criteria including a criterion that is satisfied when the paper is a first type (e.g., as described above) having content (e.g., text, characters, and/or images), the electronic device 101 displays, via display 120, user interface element 408 (e.g., virtual object) used to identify a region of interest within the three-dimensional environment 400 at a location within the three-dimensional environment 400 corresponding to a respective location of the paper 404 identified by the electronic device 101. In some examples, user interface element 408 has one or more characteristics and/or one or more functions of the user interface element 306 in FIG. 3A.

In some examples, after identifying the paper 404 and displaying the user interface element 408, the electronic device 101 performs a video-passthrough enhancement operation including capturing, via the one or more input devices, one or more first images of the paper 404 contained within the user interface element 408, and generating for display, via the display 120, one or more second images based on the one or more first images. In some examples, the one or more second images have higher pixel resolution than the one or more first images. For example, in FIG. 4B, the electronic device 101 displays a second user interface element 412 that includes an image having a higher pixel resolution than a view of the paper 404 via the display 120. In some examples, the one or more second images have a different enhanced visual characteristic, such as an increased level of detail, improved clarity, higher quality, increased size, increased contrast, increased sharpness, increased color vibrancy, increased text readability, less noise, or the like. In some examples, the second user interface element 412 is displayed at a location within the three-dimensional environment 400 different from the respective location of the paper 404, as shown in FIG. 4B. In some examples, the electronic device 101 displays the second user interface element 412 at a location such that it is viewed by the user from a more ergonomic viewing position than the viewing position associated with viewing the paper 404. For example, in FIG. 4B, the electronic device 101 displays the second user interface element 412 aligned with the line of sight of the user and adjacent to the paper 404. In some examples, the electronic device 101 determines the line of sight of the user based on attention (e.g., gaze) and/or posture of the user. In some examples, while and/or in response to displaying the second user interface element 412 adjacent to the paper 404, the electronic device 101 changes an orientation of the second user interface element 412 that is different than an orientation of the paper 404 (e.g., independent of an orientation of the paper 404). For example, and as shown in FIG. 4B, the electronic device 101 displays the second user interface element 412 with an orientation directed towards the viewpoint of the user of the electronic device.

Thus, in some examples, displaying the second user interface element 412 having the higher pixel resolution image of the paper 404 than the view of the paper 404 via the display 120 and at a location within the three-dimensional environment 400 adjacent to the respective location of the paper 404 provides an improvement in the delivery of enhanced content that is comfortable and ergonomic, which reduces eye strain of the user, thereby avoiding potential physical discomfort for the user caused by viewing content within the three-dimensional environment 400. In some examples, and as shown in FIG. 4C, the electronic device 101 provides a side-by-side view of the physical paper and the virtual object (e.g., second user interface element 412 including the enhanced content). In some examples, the electronic device 101 captures video imagery of the respective region of the three-dimensional environment 400 that includes the paper and displays the computer-enhanced video imagery, via the second user interface element 412. For example, the enhanced video imagery includes content corresponding to content of the paper 404 in the three-dimensional environment 400 and a portion 414 of the hand of the user corresponding to the hand 410 of the user in the three-dimensional environment 400. Thus, in some examples, the electronic device 101 displays an enhanced view of content viewable by the user in real-time, such that the second user interface element 412 includes an enhanced image based on a captured live image as the user interacts with the paper 404 using writing instrument 406, as shown in FIG. 4C. In some examples, the enhanced content includes magnified content with a size larger than the size of the original content of the paper 404. In some examples, the enhanced content includes translated content in a language selected by the user, different from the language of the original content of the paper 404.

FIGS. 5A-5C illustrate another example of presenting enhanced video-passthrough in a three-dimensional environment according to some examples of the disclosure. FIG. 5A illustrates electronic device 101 (e.g., electronic device 101 of FIG. 1; and electronic device 201 of FIG. 2) presenting a three-dimensional environment 500 (e.g., an extended reality (XR) environment, a computer-generated environment, etc.) according to some examples of the disclosure. The three-dimensional environment 500 is visible from a viewpoint of a user of the electronic device 101. In some examples, the electronic device 101 has one or more characteristics and/or one or more functions of the electronic device 101 in FIG. 3A. As shown in FIG. 5A, the electronic device 101 and a table 504 are located in the physical environment of the three-dimensional environment 500. As illustrated in FIG. 5A, a monitor 502 is on top of the table 504. In FIG. 5A, the electronic device 101 determines that the monitor 502 is displaying a webpage 506a that includes content 506b. In some examples, the electronic device 101 may be configured to capture areas of the physical environment including the monitor 502.

In some examples, the electronic device 101 performs a video-passthrough enhancement operation on a region within the three-dimensional environment 500. For example, and as illustrated in FIG. 5A, the electronic device 101 displays, via display 120, user interface element 508 (e.g., virtual object) used to identify a region of interest within the three-dimensional environment 500. In some examples, user interface element 508 has one or more characteristics and/or one or more functions of the user interface element 306 in FIG. 3A. For example, the electronic device 101 displays the user interface element 508 with a degree of opacity such that a portion 506c of the content 506b displayed by monitor 502 is visible through the user interface element 508.

In some examples, in accordance with a determination that the location of the user interface element 508 satisfies one or more criteria, the electronic device 101 performs a video-passthrough enhancement operation. For example, the one or more criteria include a criterion that is satisfied when the electronic device 101 determines that the user interface element 508 is at a respective location for longer than a predetermined threshold of time (e.g., 0.5, 0.7, 1, 3, 5, 10, 20, or 30 seconds) without moving in accordance with user input (e.g., described above). In some examples, the one or more criteria including a criterion that is satisfied when the region contained within the user interface element 508 (e.g., the portion 506c of the content 506b) is a first type (e.g., as described above) having content (e.g., text, characters, and/or images). In some examples, performing the video-passthrough enhancement operation includes capturing, via the one or more input devices, one or more first images of the portion 506c of the content 506b contained within the user interface element 508, and generating for display, via the display 120, one or more second images based on the one or more first images. In some examples, the one or more second images have higher pixel resolution than the one or more first images. For example, in FIG. 5B, the electronic device 101 displays within user interface element an image of the portion 506c of the content 506b having a higher pixel resolution than a view of the portion 506c of the content 506b via the display 120, as previously shown in FIG. 5B. Thus, in some examples, displaying the image of the portion 506c of the content 506b having the higher pixel resolution than the view of the portion 506c of the content 506b via the display 120 provides an enhanced view of the content, which reduces eye strain of the user, thereby avoiding potential physical discomfort for the user caused by viewing content within the three-dimensional environment 500. In some examples, the one or more second images have a different enhanced visual characteristic, such as an increased level of detail, improved clarity, higher quality, increased size, increased contrast, increased sharpness, increased color vibrancy, increased text readability, less noise, or the like.

Additionally or alternatively, the electronic device 101 moves the user interface element 508 in accordance with movement of the attention (e.g., gaze) of the user. For example, the electronic device 101 detects movement of the attention of the user from being directed to the portion 506c of the webpage 506a to being directed to a second portion of the content 506b, different from the portion 506c. In some examples, in response to this detected movement of the attention of the user, the electronic device 101 moves the user interface element 508 to a second location corresponding to the second portion of the content 506b and displays this second content at a higher resolution than the original second portion of the content 506b. In some examples, displaying the enhanced content includes displaying this content having one or more visual appearances, such as a size greater than the respective size of the original content 506b displayed by the monitor 502, a degree of sharpness and/or clarity greater than the respective degree of sharpness and/or clarity of the original content 506b displayed by the monitor 502, a degree of color vibrancy (e.g., color saturation, richness, vividness) greater or more intense than the respective degree of color vibrancy of the original content 506b displayed by the monitor 502, a degree of text readability (e.g., font property, contrast, light) that is more clear or comprehensible than the respective degree of text readability of the original content 506b displayed by the monitor 502, and/or visual enhancement (e.g., bolding, underlining, highlighting, lighting, and/or the like). For example, and as shown in FIG. 5C, the electronic device 101 displays the enhanced content contained within user interface element 508 with a size greater than the original content 506b displayed by the monitor 502, as previously shown in FIG. 5A. In some examples, as the electronic device 101 moves the user interface element 508, the electronic device 101 displays respective content with a same (or similar) pixel resolution and/or visual enhancement as described herein.

It is understood that the examples shown and described herein are merely exemplary and that additional and/or alternative elements may be provided within the three-dimensional environment for presenting enhanced video-passthrough in a three-dimensional environment. It should be understood that the appearance, shape, form, and size of each of the various user interface elements and objects shown and described herein are exemplary and that alternative appearances, shapes, forms and/or sizes may be provided. For example, the virtual objects representative of application windows (e.g., user interface elements 306, 408, and/or 508) may be provided in alternative shapes than those shown, such as a rectangular shape, circular shape, triangular shape, etc. Additionally or alternatively, in some examples, the various options, user interface elements, control elements, etc. described herein may be selected and/or manipulated via user input received via one or more input devices in communication with the electronic device (or electronic devices). For example, selection input may be received via physical input devices, such as a mouse, trackpad, keyboard, etc. in communication with the electronic devices (or electronic devices), or a physical button integrated with the electronic devices (or electronic devices).

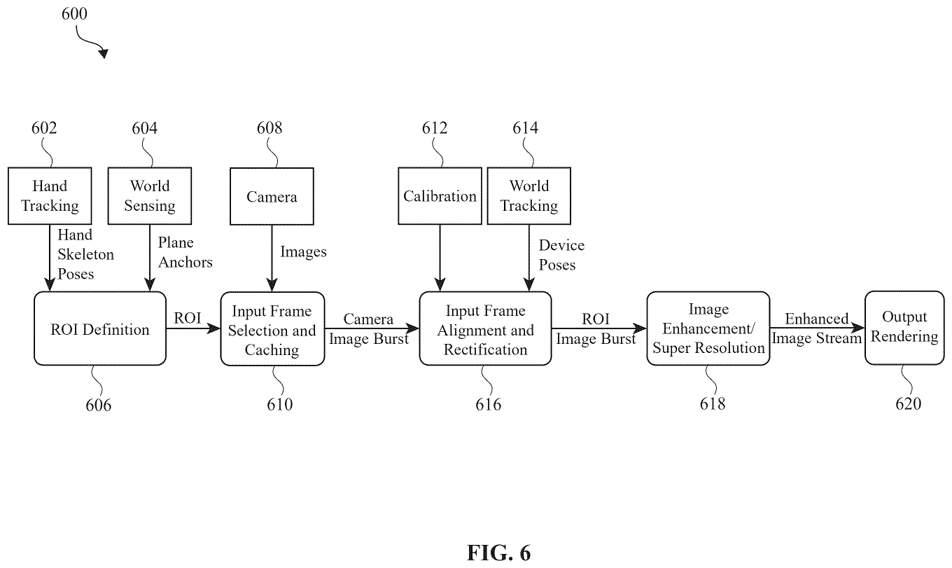

FIG. 6 illustrates an example process for generating an enhanced video-passthrough in a three-dimensional environment according to some examples of the disclosure. In some examples, the electronic device 101 (e.g., electronic device) described above with reference to FIGS. 1 and 2 can perform method 600. For example, method 600 includes the electronic device 101 defining a ROI (region of interest) (606). In some examples, the ROI is contained within a user interface element or bounding window (or volume) (e.g., user interface element 306 in FIGS. 3A-3G or user interface element 508 in FIGS. 5A-5C) as described above. In some examples, the ROI corresponds to a physical object (e.g., paper 404 in FIGS. 4A-4C) as described above. Additionally or alternatively, the electronic device 101 defines a plurality of ROIs. For example, the electronic device 101 displays more than one user interface element 508 within the three-dimensional environment 500 in FIGS. 5A-5C. In some examples, the electronic device 101 displays two or more ROIs overlapping with one another to optionally display a larger ROI than the respective, separate two or more ROIs. In some examples, the ROI is based on hand skeleton poses of the user of the electronic device 101 and/or plane anchors of the three-dimensional environment. In some examples, the hand skeleton poses are captured based on or more hand tracking 602 sensors of the electronic device 101. In some examples, the plane anchors are created by the electronic device 101 using one or more world sensing 604 and/or environment/surface detecting technologies. In some examples, the ROI is defined as a two-dimensional region in a given camera frame. For example, the electronic device 101 may track, stabilize, and enhance this two-dimensional region using two-dimensional homography tracking.

In some examples, after the ROI is defined, the electronic device 101 captures one or more images of the three-dimensional environment captured by the plurality of image sensors of the electronic device 101 (optionally also referred to as main camera 608). In some examples, the electronic device 101 may then perform an input frame alignment and rectification process 616 on the captured one or more images (e.g., camera image burst/series of images) to ensure the captured one or more images are synchronized, consistent, and are high quality images with minimal motion artifacts so as to output a stabilized image stream as described in more detail below.

Additionally or alternatively, the electronic device 101 performs input frame selection and caching 610 using the one or more images captured from main camera 608. In some examples, performing input frame selection reduces the processing time and associated computational complexity by processing only select frames, such as, for example, frames that meet a quality threshold related to image resolution, color saturation, sharpness, lighting, or other qualitative measurement before undergoing further processing. In some examples, caching improves performance, reduces latency, and reduces jitter by utilizing frames from a recent period of time and associated data. In some examples, after the process of input frame selection and caching 610, the electronic device 101 performs an input frame alignment and rectification process 616 on the resulting frames (e.g., camera image burst/series of images). In some examples, the electronic device 101 utilizes one or more alignment techniques such as feature-based alignment, optical flow-based alignment, homography transformation alignment, or other alignment technique. In some examples, the electronic device 101 utilizes one or more rectification techniques, such as stereo/epipolar rectification or other rectification process.

In some examples, the electronic device 101 utilizes one or more device poses from a timestamp of the ROI obtained from a world tracking unit 614. In some examples, the electronic device 101 includes and/or is in communication with world tracking unit 614 to obtain, for a location in the three-dimensional environment, reference coordinates in the AR/VR coordinate system. The electronic device 101 also obtains camera calibration 612 including one or more extrinsic and/or intrinsic camera (e.g., image sensors) parameters (e.g., focal length, principal point, skew, and/or distortion) of the electronic device 101 along with the device poses of the electronic device 101 to extract the ROI from the camera image burst/series of images resulting in a plurality of ROI images/image burst. In some examples, the electronic device 101 tracks the ROI using homography tracking and utilizes an estimated homography matrix to describe the alignment of the plurality of ROI images/image burst from the different image sensors of the electronic device 101. Thus, the electronic device 101 may crop, rectify, align and/or perform another action on the ROI images/image burst.

The electronic device 101 will then perform an image enhancement/super resolution 618 process on the plurality of ROI images/image burst to output an enhanced image stream for output rendering 620 to the display 120 of the electronic device 101. In some examples, the electronic device 101 provides options, to the user, to display the image stream at a selected display frame rate (e.g., a high FPS (frames per rate)) and/or enhance the image stream. In some examples, the electronic device 101 provides user election of one or more parameters that are used to enhance the image stream, such selection of particular text, characters, images, and/or the like.

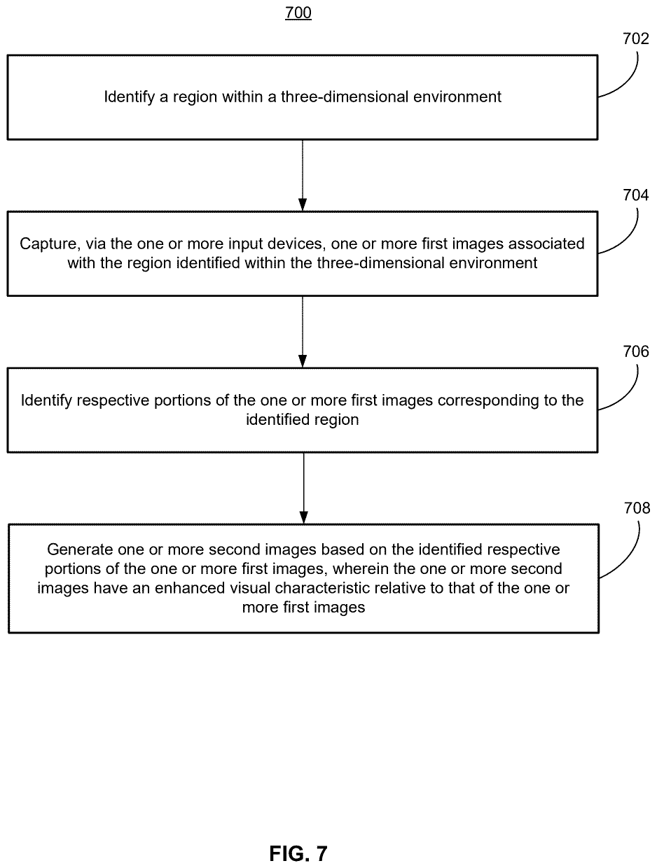

FIG. 7 illustrates a flow diagram illustrating an example process for presenting enhanced video-passthrough in a three-dimensional environment according to some examples of the disclosure. In some examples, process 700 begins at an electronic device (e.g., the first electronic device 101 in FIG. 3A) in communication with one or more input devices. In some examples, the electronic device is in communication with one or more displays (e.g., display 120 in FIG. 3A). In some examples, the electronic device identifies (702) a region within a three-dimensional environment, such as, for example, the region within the three-dimensional environment 300 captured by user interface element 306 in FIGS. 3A-3G. In some examples, the electronic device captures (704), via the one or more input devices, one or more first images associated with the region identified within the three-dimensional environment, such as images of physical poster 304b in FIGS. 3A-3G. In some examples, the electronic device identifies (706) respective portions of the one or more first images corresponding to the identified region, such as described in method 600 in FIG. 6. In some examples, the electronic device generates (710) one or more second images based on the identified respective portions of the one or more first images, wherein the one or more second images have an enhanced visual characteristic relative to that of the one or more first images, such as image 310 in FIGS. 3B-3G.

It is understood that process 700 is an example and that more, fewer, or different operations can be performed in the same or in a different order. Additionally, the operations in process 700 described above are, optionally, implemented by running one or more functional modules in an information processing apparatus such as general-purpose processors (e.g., as described with respect to FIGS. 2A-2B) or application specific chips, and/or by other components of FIGS. 2A-2B.

Therefore, according to the above, some examples of the disclosure are directed to a method, comprising at an electronic device in communication with one or more input devices: identifying a region within a three-dimensional environment; capturing, via the one or more input devices, one or more first images associated with the region identified within the three-dimensional environment; identifying respective portions of the one or more first images corresponding to the identified region; and generating one or more second images based on the identified respective portions of the one or more first images, wherein the one or more second images have an enhanced visual characteristic relative to that of the one or more first images. Additionally or alternatively, identifying respective portions of the one or more first images corresponding to the identified region comprises determining a pose of the electronic device and performing an alignment and rectification operation on the one or more first images based on the pose of the electronic device. Additionally or alternatively, identifying respective portions of the one or more first images corresponding to the identified region comprises performing homography tracking of an image with respect to the one or more first images. Additionally or alternatively, the enhanced visual characteristic comprises a higher pixel resolution, increased level of detail, improved clarity, increased size, increased contrast, increased sharpness, increased color vibrancy, increased text readability, and/or less noise.

Additionally or alternatively, identifying the region within the three-dimensional environment includes presenting, via one or more displays in communication with the electronic device, a user interface element within the three-dimensional environment. Additionally or alternatively, in some examples, the method further comprises while presenting the user interface element within the three-dimensional environment, the electronic device detects, via the one or more input devices, user input corresponding to a request to move the user interface element to a second region within the three-dimensional environment, different from the region. In some examples, in response to detecting the user input, in accordance with a determination the user input satisfies one or more criteria, the electronic device captures, via the one or more input devices, one or more third images associated with the second region within the three-dimensional environment; identifies respective portions of the one or more third images corresponding to the second region; and generates one or more fourth images based on the identified respective portions of the one or more third images, wherein the one or more fourth images have an enhanced visual characteristic relative to that of the one or more third images. In some examples, in response to detecting the user input, in accordance with a determination the user input does not satisfy the one or more criteria, the electronic device presents, via the one or more displays, an indication that the user input does not satisfy the one or more criteria.

Additionally or alternatively, in some examples, the method further comprises presenting, via one or more displays in communication with the electronic device, a user interface element including the one or more second images overlaid on the region identified within the three-dimensional environment. Additionally or alternatively, in some examples, the method further comprises: while presenting the user interface element including the one or more second images overlaid on the region identified within the three-dimensional environment, the electronic device detects, via the one or more input devices, user input corresponding to a request to move the user interface element including the one or more second images to a second region within the three-dimensional environment, different from the region. In some examples, in response to detecting the user input, the electronic device presents the user interface element including the one or more second images overlaid on the second region.

Additionally or alternatively, in some examples, the method further comprises while presenting the user interface element including the one or more second images overlaid on the region identified within the three-dimensional environment, the electronic device detects, via the one or more input devices, user input corresponding to a request to further enhance a portion of the one or more second images. In response to detecting the user input, the electronic device presents the user interface element including a further enhanced portion of the one or more second images overlaid on the region. Additionally or alternatively, identifying the region within the three-dimensional environment includes identifying an object within the three-dimensional environment and presenting, via one or more displays in communication with the electronic device, a user interface element at a location within the three-dimensional environment corresponding to a respective location of the object identified within the three-dimensional environment.

Additionally or alternatively, identifying the region within the three-dimensional environment includes presenting, via one or more displays in communication with the electronic device, a user interface element at a first location and an object at a second location, different from the first location, within the three-dimensional environment. In some examples, while presenting the user interface element at the first location and the object at the second location within the three-dimensional environment, the electronic device detects, via the one or more input devices, user input corresponding to a request to move the user interface element from the first location within the three-dimensional environment. In some examples, in response to detecting the user input, the electronic device moves the user interface element in the three-dimensional environment in accordance with the user input. In some examples, in accordance with a determination that the user input corresponds to movement of the user interface element to a third location within the three-dimensional environment, different from the second location, that is within a threshold distance of the second location of the object, the electronic device moves the user interface element to a respective location, different from the third location, corresponding to the object. In some examples, in accordance with a determination that the user input corresponds to movement of the user interface element to a fourth location within the three-dimensional environment that is outside the threshold distance of the second location of the object, the electronic device moves the user interface element to the fourth location within the three-dimensional environment. Additionally or alternatively, the method further comprises in response to detecting the user input, and in accordance with the determination that the user input corresponds to movement of the user interface element to the third location within the three-dimensional environment, the electronic device changes a size of the user interface element to present the user interface element with a size at the respective location that is based on a size of the object. Additionally or alternatively, the respective location is adjacent to the second location of the object. Additionally or alternatively, moving the user interface element to the respective location includes changing an orientation of the user interface element that is different than an orientation of the object. Additionally or alternatively, the method further comprises while capturing the one or more first images, the electronic device determines that one or more criteria are satisfied, including a criterion that is satisfied when movement of a viewpoint of a user of the electronic device causes the viewpoint to be located further than a threshold distance from a respective location associated with capturing the one or more first images. Additionally or alternatively, the method further comprises in response to the determination that the one or more criteria are satisfied, the electronic device presents, via one or more displays in communication with the electronic device, a notification to recenter the viewpoint of the user relative to the respective location. Additionally or alternatively, the method further comprises while capturing the one or more first images, the electronic device determines that one or more criteria are satisfied, including a criterion that is satisfied when movement of a viewpoint of a user of the electronic device causes the viewpoint to be located further than a threshold distance from a respective location associated with capturing the one or more first images. Additionally or alternatively, the method further comprises in response to the determination that the one or more criteria are satisfied, the electronic device transmits information associated with the movement of the viewpoint of the user of the electronic device to a second electronic device in communication with the electronic device, wherein the information causes a user interface element displayed by the second electronic device to be moved in accordance with the movement of the viewpoint of the user of the electronic device.

Attention is now directed towards example user interactions with an enhanced video that is displayed in a three-dimensional environment presented at a first electronic device (e.g., corresponding to electronic device 201 in FIG. 2A).

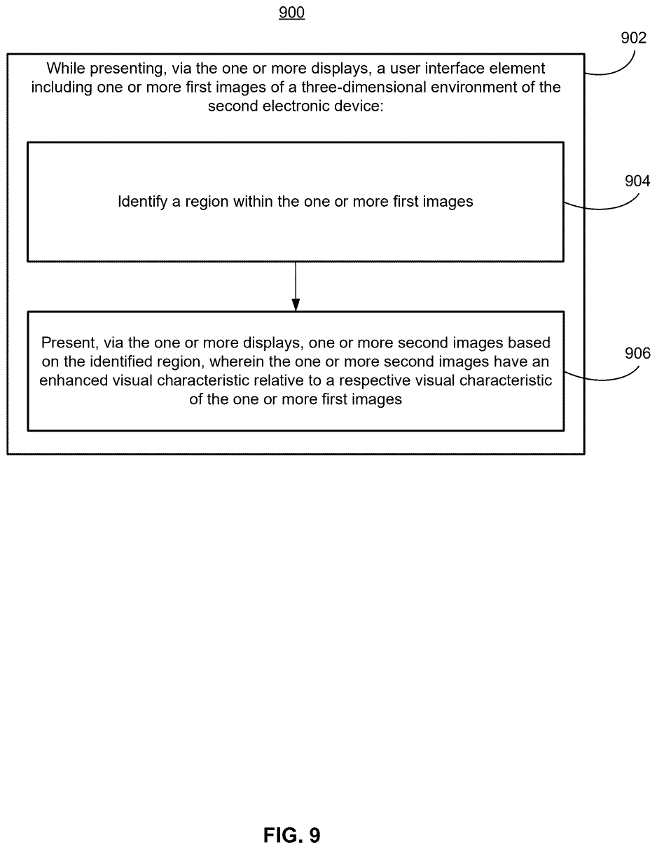

FIGS. 8A-8J illustrate examples of presenting an enhanced video in a three-dimensional environment according to some examples of the disclosure. The examples in these figures are used to illustrate the process described below, including the process described with reference to FIG. 9. Although FIGS. 8A-8J illustrate various examples of ways the first electronic device is able to perform the process described below with respect to FIG. 9, it should be understood that these examples are not meant to be limiting, and the first electronic device is able to perform the process described below with reference to FIG. 9 in ways not expressly described with reference to FIGS. 8A-8J.

Users interact with electronic devices in many different manners. In some examples, and as shown in FIG. 8A, a first electronic device 101a is in communication with one or more displays (e.g., display 120a) and one or more input devices (e.g., image sensors 114a through 114c described in more detail in FIG. 1 with reference to image sensors 114a through 114c). The examples described below provide ways in which the first electronic device 101a presents enhanced images and/or video that are based on received images and/or video from a second electronic device (e.g., second electronic device 101b in FIG. 8I described in more detail below), different from the first electronic device 101a. For example, the first electronic device 101a presents, to a remote user of the first electronic device 101a, an enhanced real-time video feed captured at the second election device (e.g., at a different location from a respective location of the first electronic device 101a). In some examples, enhancing one or more characteristics of the real-time video feed automatically (e.g., without detecting user input to expressly enhance the real-time video feed) enables an improved user experience that provides greater visual quality of the real-time video feed in a manner that reduces latency, reduces noise, reduces a dependency on the second electronic device, provides resolution upscaling, provides region of interest cropping, and/or or increased stabilization that is efficient and resource conscious, thereby enhancing the operability of the electronic device. It is understood that people use electronic devices. When a person uses an electronic device, such as first electronic device 101a, that person is optionally referred to as a user of the first electronic device 101a.

In some examples, and as shown in FIG. 8A, the first electronic device 101a is in a communication session with the second electronic device (e.g., second electronic device 101b in FIG. 8I described in more detail below). For example, the first electronic device 101a and the second electronic device are configured to communicate (e.g., wirelessly, such as via Wi-Fi, a server (e.g., wireless communications terminal), or any other wireless communication network) to exchange data, instructions, and/or other indications for performing one or more operations at the first electronic device 101a and/or the second electronic device. In some examples, the first electronic device 101a and the second electronic device are not located in a same physical location. In some examples, the first electronic device 101a and the second electronic device optionally correspond to or are similar to electronic device 101 discussed above with reference to FIGS. 1, 3A-3G, and/or electronic device 201 in FIGS. 2A-2B. In some examples, the second electronic device is optionally referred to as the transmitting device. In some examples, the first electronic device 101a is optionally referred to as the remote device. In an example user case, the first electronic device 101a is associated with a customer service representative configured to provide troubleshooting services to a user (e.g., client) of the second electronic device. The client is physically co-located with a physical machine 832 undergoing troubleshooting. In some examples, the first electronic device 101a receives a real-time video feed of the machine 832. The first electronic device 101a presents this video feed, thereby enabling the customer service representative to remotely inspect the machine 832 and guide the client through corrective actions as described with reference to FIGS. 8A-8J. For example, an example use case is described in which the customer service representative provides remote support to the client for removing an object (e.g., object 828 in FIG. 8A) from machine 832, wherein the object is not intended to be (e.g., should not be) within the machine 832 when the machine is operating normally. For example, object 828 optionally includes debris, a misplaced machine component, or other exterior object. The object may be detected by the first electronic device 101a via the real-time video feed as described with reference to FIGS. 8E-8H.

In some examples, and as shown in FIG. 8A, the first electronic device 101a receives one or more first images 804c (e.g., live video stream) of a three-dimensional environment of the second electronic device from the second electronic device and presents, via display 120a, the one or more first images 804c in a user interface 804a (e.g., virtual object) within the three-dimensional environment 800a of the first electronic device 101a. In some examples, the three-dimensional environment 800a has one or more characteristics of the three-dimensional environment 300 of FIGS. 3A-3G. For example, in FIG. 8A, the three-dimensional environment 800a includes a plurality of virtual objects (e.g., user interface 804a, user interface element 804d, and user interface element 804e) and a real-world object (e.g., a lamp 802). In some examples, as shown in overhead view 812 in FIG. 8A, the first electronic device 101a is being used by (e.g., worn on a head of) a first user 810, and the user interface 804a is positioned in front of the first user 810 in the three-dimensional environment 800a.

In some examples, presenting the user interface 804a includes presenting, via the display 120a, user interface element 804d that identifies the one or more first images 804c as being associated with the second electronic device (e.g., “Sally's window). In some examples, presenting the user interface 804a includes presenting, via the display 120a, user interface element 804e that, when selected, causes the first electronic device 101a to move user interface 804a including the one or more first images 804c, user interface element 804d, and user interface element 804e within the three-dimensional environment 800a. In some examples, the user interface 804a includes user interface element 804b that, when selected, causes the first electronic device 101a to present a second user interface element, such as second user interface element 814a in FIG. 8B. For example, in FIG. 8A, the first electronic device 101a detects air pinch gesture 808a while attention 806a (e.g., gaze) of the first user 810 of the first electronic device 101a is directed to user interface element 804b. In some examples, detecting air pinch gesture 808a has one or more characteristics of detecting air pinch gesture 308a as described above with reference to FIG. 3A. In some examples, in response to detecting air pinch gesture 808a while attention 806a (e.g., gaze) of the first user 810 of the first electronic device 101a is directed to user interface element 804b, the first electronic device 101a presents, via display 120a, the second user interface element 814a including second user interface component 814b, as shown in FIG. 8B. In some examples, second user interface component 814b has one or more characteristics of user interface element 804e in FIG. 8A.

In some examples, the second user interface element 814a is interactable to select and/or define a region of the one or more first images 804c to visually enhance, as discussed in more detail below. In some examples, the second user interface element 814a optionally serves as a bounding box or container (e.g., in any shape) for a region of the one or more first images 804c. For example, in FIG. 8B, the second user interface element 814a includes a transparent box or window type user interface element that surrounds a first region within the one or more first images 804c. In some examples, the first region included in the second user interface component 814b includes content 818, as shown in FIG. 8B. For example, content 818 optionally includes machine identification information, metrics, diagnostic information, maintenance instructions, user interfaces including information generated/output by the machine, and/or the like. In some examples, the content 818 is provided in a language different from a preferred language of the first user of the first electronic device 101a or is illegible or is presented at a size or scale that is insufficient for human readability.

In some examples, the first electronic device 101a presents one or more second images based on the first region including the content 818. For example, in FIG. 8B, the first electronic device 101a detects air pinch gesture 808b and voice input 816 requesting to translate content 818 while attention 806b of the first user 810 is directed to content 818. In some examples, detecting air pinch gesture 808b has one or more characteristics of detecting air pinch gesture 308a as described above with reference to FIG. 3A. In some examples, in response to detecting air pinch gesture 808b and voice input 816 while attention 806b of the first user 810 of the first electronic device 101a is directed to content 818, the first electronic device 101a presents, via display 120a, one or more second images, such as image 818b in FIG. 8C, corresponding to a visual enhancement of the first region included in the second user interface component 814b. For example, image 818b is presented with an enhanced visual characteristic relative to a respective visual characteristic of the one or more first images 804 that includes content 818. For example, and as shown in FIG. 8C, presenting the image 818b with the enhanced visual characteristic includes translating the content 818 into the preferred language of the first user 810 and/or presenting the content 818 at a size or scale that is sufficient for human readability as shown by image 818b. In some examples, the enhanced visual characteristic includes a resolution of the image 818b that is higher than a respective resolution of content 818. In some examples, the enhanced visual characteristic includes a level of detail, clarity, quality, contrast, color vibrancy, text readability, and/or sharpness of the image 818b that is greater than a respective level of detail, clarity, quality, contrast, color vibrancy, text readability, and/or sharpness of the content 818. In another example, the enhanced visual characteristic includes an amount of noise of the image 818b that is less than a respective amount of noise of the content 818. In some examples, presenting image 818b includes performing a process that includes one or more characteristics as performing an image enhancement/super resolution 618 process described above with reference to FIG. 6.

In some examples, the first electronic device 101a initiates a process to resize and/or move the second user interface element 814a within the three-dimensional environment 800a of the first electronic device 101a. For example, in FIG. 8C, the first electronic device 101a detects user input corresponding to a request to move the second user interface element 814a. For example, the first electronic device 101a detects a sequence of one or more inputs that includes an air pinch gesture, optionally while attention 806c of the first user 810 of the first electronic device 101a is directed to second user interface component 814b of the second user interface element 814a. In response to detecting this sequence of one or more inputs, the first electronic device 101a selects the second user interface element 814a. In some examples, the first electronic device 101a detects that the sequence of one or more inputs includes movement of the air pinch gesture from a first location 808c to a second location 808cc in space, as shown in FIG. 8C. In response to detecting the sequence of one or more inputs, the first electronic device 101a moves the second user interface element 814a in accordance with the movement of the air pinch gesture. For example, the first electronic device 101a moves the second user interface element 814a from a first location within the three-dimensional environment 800a to a second location within the three-dimensional environment 800a, while attention 806d of the first user 810 of the first electronic device 101a is directed to the second user interface component 814b of the second user interface element 814a, as shown in FIG. 8D. In some examples, moving the second user interface element 814a does not cause the first electronic device 101a to maintain presentation of the image 818b (e.g., to maintain presentation of the one or more second images having the enhanced visual characteristic). For example, and as shown in FIG. 8D, the first electronic device 101 presents, via the display 120a, the second user interface element 814a including a second region of the one or more first images 804c, different from the first region of the one or more first images 804c displayed in FIG. 8B, that does not include the enhanced visual characteristic.

In some examples, while presenting the second user interface element 814a including the second region of the one or more first images 804c (e.g., at the second location), as shown in FIG. 8D, the first electronic device 101a optionally detects the attention of the user, such as attention 806d, directed to content 818. In some examples, in response to detecting the attention of the user directed to content 818, the first electronic device 101a optionally presents image 818b (e.g., the enhanced version of content 818), as described in FIG. 8C.

In some examples, while presenting the second user interface element 814a including the second region of the one or more first images 804c, as shown in FIG. 8D, the first electronic device 101a detects an object, such as object 828, in the one or more first images 804c. For example, and with respect to the customer service representative and troubleshooting use case, the first electronic device 101a detects the object 828 within the machine 832 that is not expected to be and/or that should not be present within the machine 832 in accordance with a specification of the machine 832. In some examples, the first electronic device 101a determines that the object 828 is not intended to be present within the machine 832 based on a visual identification process that includes one or more operations to: identify the machine 832; compare the one or more first images 804c against a reference model of the machine 832 (e.g., a design specification of the expected configuration of the machine 832 and/or a historical pre-recorded image of the machine 832); and/or analyze the comparison to detect this unexpected object 828 and/or any other deviations from the reference model of the machine 832. In some examples, the first electronic device 101a obtains the specification, the reference model, and/or a pre-recorded model image of the machine 832 from a remote server in communication with the first electronic device 101a, from a local processor (e.g., maintained by the first electronic device 101a optionally from a computer-aided design (CAD) and drafting software application or other application operating on the first electronic device 101a) for retrieving a particular specification and/or machine information, and/or from the second electronic device (e.g., optionally transmitted from the second electronic device along with the one or more first images).

In some examples, in response to detecting object 828, the first electronic device 101a, presents, via display 120a, an indication that the object 828 has been detected and/or identified by the first electronic device 101a. In some examples, and a shown in FIG. 8E, presenting the indication that the object 828 has been identified includes presenting, via the display 120a, a user interface element 822 at a location within the three-dimensional environment 800a of the first electronic device 101a corresponding to a respective location of the object 828 identified within the one or more first images. In some examples, presenting the user interface element 822 includes applying a visual treatment to emphasize the object 828 relative to other objects or parts in the machine 832, such as highlighting the location of the object 828 and/or performing an image enhancement/super resolution 618 process described above with reference to FIG. 6 to the region of the one or more first images 804c that includes the object 828. For example, in response to detecting the object 828, the first electronic device 101a presents one or more second images based on the location of the identified object 828, wherein the one or more second images have an enhanced visual characteristic (e.g., level of detail, clarity, quality, contrast, sharpness, color vibrancy, text readability, and/or any of the characteristics described above) relative to the one or more first images. For example, in FIG. 8E, the first electronic device 101a presents the one or more second images in a manner in which the user interface element 822 appears as a magnifying element such that object 828 appears enlarged relative to surrounding portions of the one or more second images (e.g., portions of the video feed of the machine 832).

In some examples, and as shown in FIG. 8E, while presenting the one or more second images including the user interface element 822 as described above, the first electronic device 101a presents, via the display 120a, a notification 824a that, when selected, causes the first electronic device 101a to transmit the one or more second images to the second electronic device. For example, notification 824a includes a first option 824b that, when selected causes the first electronic device 101a to transmit the one or more second images including the user interface element 822 to the second electronic device; and a second option 824c that, when selected, causes the first electronic device 101a to forgo transmitting the one or more second images including the user interface element 822 to the second electronic device. In some examples, prior to presenting the one or more second images including the user interface element 822, the first electronic device 101a presents, via the display 120a, a notification of sharing the one or more second images including the user interface element 822 to the second electronic device. In some examples, this notification of sharing the one or more second images including the user interface element 822 has one or more characteristics of notification 824a in FIG. 8E.

In some examples, the first electronic device 101a changes a view of the one or more second images (e.g., the region of the one or more first images 804c contained within the second user interface element 814a). For example, in FIG. 8E, the first electronic device 101a detects air pinch gesture 808e and voice input 820 requesting to zoom-in on the second user interface element 814a while attention 806e of the first user 810 is directed to a region of the one or more second images (e.g., contained within the second user interface element 814a). In some examples, detecting air pinch gesture 808e has one or more characteristics of detecting air pinch gesture 308a as described above in FIG. 3A. In some examples, in response to detecting air pinch gesture 808e and voice input 820 while attention 806e of the first user 810 of the first electronic device 101a is directed to the region of the one or more second images, the first electronic device 101a presents, via display 120a, a zoomed-in view of the one or more second images, such as shown within the second user interface element 814a in FIG. 8F. In some examples, presenting this zoomed-in view includes cropping the region of interest contained within the second user interface element 814a from the one or more first images 804c (e.g., video feed from the second electronic device) and scaling the cropped region, as shown in FIG. 8F.

In some examples, and as shown in FIG. 8F, while presenting the second user interface element 814a in a first location of the three-dimensional environment 800a of the first electronic device 101a, the first electronic device 101a detects a sequence of one or more inputs that includes an air pinch gesture, optionally while attention 806f of the first user 810 of the first electronic device 101a is directed to second user interface component 814b of the second user interface element 814a, and movement of the air pinch gesture from a first location 808f to a second location 808ff in space, as shown in FIG. 8F. In response to detecting the sequence of one or more inputs, the first electronic device 101a optionally selects the second user interface element 814a for movement, and moves the second user interface element 814a in accordance with the movement of the air pinch gesture. For example, the first electronic device 101a moves the second user interface element 814a from the first location within the three-dimensional environment 800a to a second location within the three-dimensional environment 800a, while attention 806f of the first user 810 of the first electronic device 101a is directed to the second user interface component 814b of the second user interface element 814a, as shown in FIG. 8G.

In some examples, moving the second user interface element 814a causes the first electronic device 101a to maintain a view or presentation of the zoomed-in view of the one or more second images. For example, and as shown in FIG. 8G, the first electronic device 101a presents, via the display 120a, the second user interface element 814a including the zoomed-in view of the one or more second images at the second location within the three-dimensional environment 800a, as shown by the overhead view 812. In some examples, the first electronic device 101a further performs an action to undock (e.g., release or separate) the second user interface element 814a from the first location in the three-dimensional environment 800a that is still occupied by the user interface 804a including the one or more first images 804c, and move the second user interface element 814a to the second location within the three-dimensional environment 800a in accordance with the movement of the air pinch gesture, as shown in the overhead view 812 in FIG. 8G.

In some examples, the first electronic device 101a presents one or more annotations overlaid on the one or more second images and the one or more first images. In some examples, while the first electronic device 101a presents the second user interface element 814a including the one or more second images, the first electronic device 101a detects user input corresponding to a request to add an annotation to the one or more second images. For example, and as shown in FIG. 8G, detecting the user input corresponding to the request to add the annotation includes detecting a sequence of one or more inputs including air pinch gesture 808g and voice input 838 requesting to add the annotation (e.g., “Add arrow here”), while attention 806g of the first user 810 is directed to a region of the one or more second images (e.g., contained within the second user interface element 814a). In some examples, detecting air pinch gesture 808g has one or more characteristics of detecting air pinch gesture 308a as described above with reference to FIG. 3A. In some examples, in response to detecting air pinch gesture 808g and voice input 838 while attention 806g of the first user 810 of the first electronic device 101a is directed to the region of the one or more second images, the first electronic device 101a presents, via display 120a, an arrow icon 836a or graphic. In some examples, the first electronic device 101a detects that the sequence of one or more inputs includes movement of the air pinch gesture from a first location of air pinch gesture 808g to a second location 808gg in space, as shown in FIG. 8G. In response to detecting the sequence of one or more inputs, the first electronic device 101a moves the arrow icon 836a in accordance with the movement of the air pinch gesture. For example, the first electronic device 101a moves the arrow icon 836a to a location as shown in FIG. 8G. In some examples, after moving and presenting the arrow icon 836a at the location as shown in FIG. 8G, the first electronic device 101a transmits the one or more second images including the arrow icon 836a to the second electronic device causing a representation corresponding to the arrow icon 836a to be presented via a display of the second electronic device. For example, and as shown in FIG. 8I, a representation 836b corresponding to the arrow icon 836a of FIG. 8G is presented as overlaid on the machine 832 of the environment of the second electronic device 101b. In some examples, the transmission and presentation of one or more annotations, such as the representation 836b corresponding to the arrow icon 836a, enables the first electronic device 101a and/or the first user 810 of the first electronic device 101a to guide the second user in locating object 828. For example, and as shown in FIG. 8G, a hand 826 of the second user is detected in a location corresponding to the arrow icon 836a and in FIG. 8H, the hand 826 of the second user is presented as removing the object 828 from the machine 832.

FIGS. 8I and 8J illustrate the first electronic device 101a moving the user interface 804a including the one or more first images 804 in accordance with a movement of a viewpoint of the user of the second electronic device. For example, FIG. 8I further illustrates a three-dimensional environment 800b of the second user 830 of the second electronic device 101b. As shown in FIG. 8I, a first portion of the three-dimensional environment 800b of the second electronic device 101b (e.g., contained within user interface 834a) is presented within the three-dimensional environment 800a of the first electronic device 101a via the user interface 804a. In some examples, the first portion that is presented is from a first viewpoint of the second user 830 of the second electronic device 101b that corresponds to a downward tilt of the head of the second user 830 relative to the machine 832, as illustrated in the side view of the second user 830. In some examples, the first portion of the three-dimensional environment 800b includes a hand 826 of the second user 830 holding the object 828 after the object 828 has been removed from a location within the machine 832 as similarly described above with reference to FIG. 8H, the removal having been performed by the second user 830 using the representation 836b as a guide indicating the location of the object 828 within the machine 832 (e.g., an arrow graphic corresponding to the arrow icon 836 in FIG. 8H, generated and positioned by the first electronic device 101a and transmitted to the second electronic device 101b). In some examples, the first electronic device 101a presents the user interface 804a at a first viewing angle (e.g., in a position and orientation corresponding to a best viewing angle determined automatically by the first electronic device 101a based on image content, user preferences, and/or in a manner in which relevant features of the machine 832 are presented at an optimal perspective).

In some examples, the first electronic device 101a receives information associated with a movement of the viewpoint of the second user 830 of the second electronic device 101b. For example, the information includes movement from the first viewpoint as shown in FIG. 8I to a second viewpoint as shown in FIG. 8J, in which the second viewpoint corresponds to an upward tilt of the head of the second user 830 relative to the machine 832. In some examples, in response to receiving this information, the first electronic device 101a moves the user interface 804a to a respective location within the three-dimensional environment 800a of the first electronic device 101a and presents a second portion of the three-dimensional environment 800b from the second viewpoint that corresponds to the upward tilt of the head of the second user 830 relative to the machine 832 as shown in FIG. 8J. For example, as shown in FIG. 8J, the first electronic device 101a moves the user interface 804a vertically upward in the three-dimensional environment 800a relative to the viewpoint of the first electronic device 101a and updates display of the one or more first images 804c to correspond to the portion of the physical environment of the second user 830 (e.g., including the hand 826 and the machine 832) that are contained within user interface 834a at the second electronic device 101b. In some examples, the first electronic device 101a aligns the user interface 804a with the updated viewpoint of the second user 830 to ensure that the first user 810 of the first electronic device 101a perceives the respective portion of the three-dimensional environment 800b (e.g., the video feed) in an orientation that corresponds to the field of view of the second user 830, thereby enabling the first user 810 to provide more precise guidance to the second user 830, as one benefit.

FIG. 9 illustrates a flow diagram illustrating an example process for presenting enhanced video in a three-dimensional environment according to some examples of the disclosure. In some examples, process 900 begins at a first electronic device (e.g., the first electronic device 101a in FIG. 8A) in communication with one or more displays and one or more input devices. In some examples, while presenting, via the one or more displays, a user interface element including one or more first images of a three-dimensional environment of the second electronic device (902), such as user interface 804a including the one or more first images 804 in FIG. 8A, the first electronic device identifies (904) a region within the one or more first images, such as the region contained in the second user interface element 814a in FIG. 8B. In some examples, the first electronic device presents (906), via the one or more displays, one or more second images based on the identified region, such as image 818b in FIG. 8C, wherein the one or more second images have an enhanced visual characteristic relative to a respective visual characteristic of the one or more first images, such as, for example, enlarged, translated text included in image 818b in FIG. 8C.

It is understood that process 900 is an example and that more, fewer, or different operations can be performed in the same or in a different order. Additionally, the operations in process 900 described above are, optionally, implemented by running one or more functional modules in an information processing apparatus such as general-purpose processors (e.g., as described with respect to FIGS. 2A-2B) or application specific chips, and/or by other components of FIGS. 2A-2B.

Therefore, according to the above, some examples of the disclosure are directed to a method comprising, at a first electronic device in communication with one or more input devices, one or more displays, and a second electronic device. In some examples, while presenting, via the one or more displays, a user interface element including one or more first images of a three-dimensional environment of the second electronic device, the first electronic device identifies a region within the one or more first images and presents, via the one or more displays, one or more second images based on the identified region, wherein the one or more second images have an enhanced visual characteristic relative to a respective visual characteristic of the one or more first images. Additionally or alternatively, the enhanced visual characteristic includes a resolution of the one or more second images that is higher than a respective resolution of the one or more first images. Additionally or alternatively, the enhanced visual characteristic includes a level of detail, clarity, quality, contrast, color vibrancy, text readability, or sharpness of the one or more second images that is greater than a respective level of detail, clarity, quality, contrast, color vibrancy, text readability, or sharpness of the one or more first images. Additionally or alternatively, the enhanced visual characteristic includes an amount of noise of the one or more second images that is less than a respective amount of noise of the one or more first images.

Additionally or alternatively, identifying the region within the one or more first images includes the first electronic device presenting, via the one or more displays, a second user interface element that includes the one or more second images within a three-dimensional environment of the first electronic device. Additionally or alternatively, the second user interface element is selectable to initiate a process to re-size and/or move the second user interface element within the three-dimensional environment of the first electronic device. Additionally or alternatively, identifying the region within the one or more first images includes the first electronic device identifying an object within the one or more first images and presenting, via the one or more displays, a second user interface element that includes the one or more second images, wherein the second user interface element is presented at a location within a three-dimensional environment of the first electronic device corresponding to a respective location of the object identified within the one or more first images. Additionally or alternatively, identifying the region within the one or more first images includes the first electronic device detecting, via the one or more input devices, user input corresponding to a request to capture the region within the one or more first images and presenting, via the one or more displays, a second user interface element that includes the one or more second images within the user interface element in accordance with the user input.

Additionally or alternatively, in some examples, the method further comprises prior to presenting the one or more second images based on the identified region, the first electronic device presents, via the one or more displays, a notification of sharing the identified region to the second electronic device. Additionally or alternatively, in some examples, the method further comprises while presenting the one or more second images based on the identified region, the first electronic device presents, via the one or more displays, a notification that, when selected, causes the first electronic device to transmit the one or more second images to the second electronic device. Additionally or alternatively, in some examples, the one or more second images are presented as being contained within a second user interface element and the second user interface element is presented in a location of a three-dimensional environment of the first electronic device, different from a respective location of the user interface element that includes the one or more first images within the three-dimensional environment of the first electronic device.

Additionally or alternatively, in some examples, the method further comprises while presenting the second user interface element in the location of the three-dimensional environment of the first electronic device, the first electronic device detects, via the one or more input devices, user input corresponding to a request to move the second user interface element to a second region within the three-dimensional environment of the first electronic device. Additionally or alternatively, in some examples, in response to detecting the user input, the first electronic device moves the second user interface element to the second region within the three-dimensional environment of the first electronic device in accordance with the user input, without moving the user interface including the one or more first images. Additionally or alternatively, in some examples, the method further comprises while presenting the one or more second images based on the identified region, the first electronic device detects, via the one or more input devices, user input corresponding to a request to add an annotation to the one or more second images. Additionally or alternatively, in some examples, in response to detecting the user input, the first electronic device adds an annotation to the one or more second images in accordance with the user input and transmits the one or more second images including the annotation to the second electronic device. Additionally or alternatively, the one or more displays include a head-mounted display. Additionally or alternatively, in some examples, the method further comprises while presenting the user interface element including the one or more first images of the three-dimensional environment of the second electronic device, the first electronic device receives, via the one or more input devices, information associated with a movement of a viewpoint of a user of the second electronic device. Additionally or alternatively, in some examples, in response to receiving the information, the first electronic device moves the user interface element including the one or more first images of the three-dimensional environment of the second electronic device to a location within the three-dimensional environment of the first electronic device in accordance with the movement of the viewpoint of the user of the second electronic device.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some examples, the data utilized can include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's engagement with content.

The present disclosure recognizes that the use of such personal information data, in the present technology, can be used to the benefit of users. For example, personal information data can be used to display suggested text that changes based on changes in a user's engagement. For example, the suggested text is updated based on changes to the user's reading preferences and/or health history.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user can be notified upon initiating collection that their personal information data will be accessed and then reminded again just before personal information data is accessed by the one or more devices.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method, comprising:
at an electronic device in communication with one or more input devices:
identifying a region within a three-dimensional environment;
capturing, via the one or more input devices, one or more first images associated with the region identified within the three-dimensional environment;
identifying respective portions of the one or more first images corresponding to the identified region; and
generating one or more second images based on the identified respective portions of the one or more first images, wherein the one or more second images have an enhanced visual characteristic relative to that of the one or more first images.

2. The method of claim 1, wherein identifying respective portions of the one or more first images corresponding to the identified region comprises:
determining a pose of the electronic device; and
performing an alignment and rectification operation on the one or more first images based on the pose of the electronic device.

3. The method of claim 1, wherein the enhanced visual characteristic comprises a higher pixel resolution, increased level of detail, improved clarity, increased size, increased contrast, increased sharpness, increased color vibrancy, increased text readability, and/or less noise.

4. The method of claim 1, further comprising:
presenting, via one or more displays in communication with the electronic device, a user interface element including the one or more second images overlaid on the region identified within the three-dimensional environment.

5. The method of claim 1, wherein identifying the region within the three-dimensional environment includes:
identifying an object within the three-dimensional environment; and
presenting, via one or more displays in communication with the electronic device, a user interface element at a location within the three-dimensional environment corresponding to a respective location of the object identified within the three-dimensional environment.

6. The method of claim 1, wherein identifying the region within the three-dimensional environment includes:
presenting, via one or more displays in communication with the electronic device, a user interface element at a first location and an object at a second location, different from the first location, within the three-dimensional environment;
while presenting the user interface element at the first location and the object at the second location within the three-dimensional environment, detecting, via the one or more input devices, user input corresponding to a request to move the user interface element from the first location within the three-dimensional environment; and
in response to detecting the user input:
moving the user interface element in the three-dimensional environment in accordance with the user input, including:
in accordance with a determination that the user input corresponds to movement of the user interface element to a third location within the three-dimensional environment, different from the second location, that is within a threshold distance of the second location of the object, moving the user interface element to a respective location, different from the third location corresponding to the object; and
in accordance with a determination that the user input corresponds to movement of the user interface element to a fourth location within the three-dimensional environment that is outside the threshold distance of the second location of the object, moving the user interface element to the fourth location within the three-dimensional environment.

7. The method of claim 6, further comprising:
in response to detecting the user input:
in accordance with the determination that the user input corresponds to movement of the user interface element to the third location within the three-dimensional environment:
changing a size of the user interface element to present the user interface element with a size at the respective location that is based on a size of the object.

8. The method of claim 6, wherein:
the respective location is adjacent to the second location of the object; and
moving the user interface element to the respective location includes changing an orientation of the user interface element that is different than an orientation of the object.

9. An electronic device comprising:
one or more processors;
memory; and
one or more programs stored in the memory and configured to be executed by the one or more processors, the one or more programs including instructions for:
identifying a region within a three-dimensional environment;
capturing, via one or more input devices, one or more first images associated with the region identified within the three-dimensional environment;
identifying respective portions of the one or more first images corresponding to the identified region; and
generating one or more second images based on the identified respective portions of the one or more first images, wherein the one or more second images have an enhanced visual characteristic relative to that of the one or more first images.

10. The electronic device of claim 9, wherein identifying respective portions of the one or more first images corresponding to the identified region comprises:
determining a pose of the electronic device; and
performing an alignment and rectification operation on the one or more first images based on the pose of the electronic device.

11. The electronic device of claim 9, wherein the enhanced visual characteristic comprises a higher pixel resolution, increased level of detail, improved clarity, increased size, increased contrast, increased sharpness, increased color vibrancy, increased text readability, and/or less noise.

12. The electronic device of claim 9, wherein the one or more programs further include instructions for:
presenting, via one or more displays in communication with the electronic device, a user interface element including the one or more second images overlaid on the region identified within the three-dimensional environment.

13. The electronic device of claim 9, wherein identifying the region within the three-dimensional environment includes:
identifying an object within the three-dimensional environment; and
presenting, via one or more displays in communication with the electronic device, a user interface element at a location within the three-dimensional environment corresponding to a respective location of the object identified within the three-dimensional environment.

14. The electronic device of claim 9, wherein identifying the region within the three-dimensional environment includes:
presenting, via one or more displays in communication with the electronic device, a user interface element at a first location and an object at a second location, different from the first location, within the three-dimensional environment;
while presenting the user interface element at the first location and the object at the second location within the three-dimensional environment, detecting, via the one or more input devices, user input corresponding to a request to move the user interface element from the first location within the three-dimensional environment; and
in response to detecting the user input:
moving the user interface element in the three-dimensional environment in accordance with the user input, including:
in accordance with a determination that the user input corresponds to movement of the user interface element to a third location within the three-dimensional environment, different from the second location, that is within a threshold distance of the second location of the object, moving the user interface element to a respective location, different from the third location corresponding to the object; and
in accordance with a determination that the user input corresponds to movement of the user interface element to a fourth location within the three-dimensional environment that is outside the threshold distance of the second location of the object, moving the user interface element to the fourth location within the three-dimensional environment.

15. The electronic device of claim 14, wherein the one or more programs further include instructions for:
in response to detecting the user input:
in accordance with the determination that the user input corresponds to movement of the user interface element to the third location within the three-dimensional environment:
changing a size of the user interface element to present the user interface element with a size at the respective location that is based on a size of the object.

16. The electronic device of claim 14, wherein:
the respective location is adjacent to the second location of the object; and
moving the user interface element to the respective location includes changing an orientation of the user interface element that is different than an orientation of the object.

17. A non-transitory computer readable storage medium storing one or more programs, the one or more programs comprising instructions, which when executed by one or more processors of an electronic device, cause the electronic device to:
identify a region within a three-dimensional environment;
capture, via one or more input devices, one or more first images associated with the region identified within the three-dimensional environment;
identify respective portions of the one or more first images corresponding to the identified region; and
generate one or more second images based on the identified respective portions of the one or more first images, wherein the one or more second images have an enhanced visual characteristic relative to that of the one or more first images.

18. The non-transitory computer readable storage medium of claim 17, wherein identifying respective portions of the one or more first images corresponding to the identified region comprises:
determining a pose of the electronic device; and
performing an alignment and rectification operation on the one or more first images based on the pose of the electronic device.

19. The non-transitory computer readable storage medium of claim 17, wherein the enhanced visual characteristic comprises a higher pixel resolution, increased level of detail, improved clarity, increased size, increased contrast, increased sharpness, increased color vibrancy, increased text readability, and/or less noise.

20. The non-transitory computer readable storage medium of claim 17, wherein the one or more programs further cause the electronic device to:
present, via one or more displays in communication with the electronic device, a user interface element including the one or more second images overlaid on the region identified within the three-dimensional environment.

21. The non-transitory computer readable storage medium of claim 17, wherein identifying the region within the three-dimensional environment includes:
identifying an object within the three-dimensional environment; and
presenting, via one or more displays in communication with the electronic device, a user interface element at a location within the three-dimensional environment corresponding to a respective location of the object identified within the three-dimensional environment.

22. The non-transitory computer readable storage medium of claim 17, wherein identifying the region within the three-dimensional environment includes:
presenting, via one or more displays in communication with the electronic device, a user interface element at a first location and an object at a second location, different from the first location, within the three-dimensional environment;
while presenting the user interface element at the first location and the object at the second location within the three-dimensional environment, detecting, via the one or more input devices, user input corresponding to a request to move the user interface element from the first location within the three-dimensional environment; and
in response to detecting the user input:
moving the user interface element in the three-dimensional environment in accordance with the user input, including:
in accordance with a determination that the user input corresponds to movement of the user interface element to a third location within the three-dimensional environment, different from the second location, that is within a threshold distance of the second location of the object, moving the user interface element to a respective location, different from the third location corresponding to the object; and
in accordance with a determination that the user input corresponds to movement of the user interface element to a fourth location within the three-dimensional environment that is outside the threshold distance of the second location of the object, moving the user interface element to the fourth location within the three-dimensional environment.

23. The non-transitory computer readable storage medium of claim 22, wherein the one or more programs further cause the electronic device to:
in response to detecting the user input:
in accordance with the determination that the user input corresponds to movement of the user interface element to the third location within the three-dimensional environment:
change a size of the user interface element to present the user interface element with a size at the respective location that is based on a size of the object.

24. The non-transitory computer readable storage medium of claim 22, wherein:
the respective location is adjacent to the second location of the object; and
moving the user interface element to the respective location includes changing an orientation of the user interface element that is different than an orientation of the object.
